(19) United States
(12) Patent Application Publication
(10) Pub. No.: US 2025/0356367 A1
(43) Pub. Date: Nov. 20, 2025

(54) FLEXIBLE SCORING MECHANISM FOR ENABLING SUSTAINABLE DEPLOYMENTS IN MULTICLOUD

(71) Applicant: Dell Products L.P., Round Rock, TX (US)

(72) Inventors: Peniel Charles, Bangalore (IN); Manikandan Sethuraman, Bangalore (IN); Joseph G Kanjirathinkal, Cary, NC (US)

(21) Appl. No.: 18/667,271

(22) Filed: May 17, 2024

(51) Int. Cl. G06Q 30/018; H04L 41/0806; H04L 41/14

(52) U.S. Cl. CPC G06Q 30/018; H04L 41/0806; H04L 41/145

(57) ABSTRACT

Described is technology that facilitates refreshing of cloud computing equipment in accordance with a deployment plan to satisfy specified environmental sustainability criteria. An associated method comprises identifying, by a system operatively coupled to at least one processor, a change to use of a first cloud computing system, and based on the identifying, generating a deployment plan applicable to cloud computing at the first cloud computing system or at a second cloud computing system, wherein the deployment plan comprises configuration factors that define operation of the first cloud computing system or the second cloud computing system to satisfy specified environmental sustainability criteria.

### BACKGROUND

Various operations of a cloud computing system, including cloud computing hardware and/or software, can contribute to and/or be a detriment to environmental sustainability. As use of cloud computing continues to grow and expand, adoption of techniques to track and/or maintain focus for environment sustainability relative to cloud computing systems can be desired.

### SUMMARY

The following presents a simplified summary of the disclosed subject matter to provide a basic understanding of one or more of the various embodiments described herein. This summary is not an extensive overview of the various embodiments. It is intended neither to identify key or critical elements of the various embodiments nor to delineate the scope of the various embodiments. Its sole purpose is to present one or more concepts of the disclosure in a streamlined form as a prelude to the more detailed description that is presented later.

Described herein are one or more frameworks directed to providing a flexible scoring mechanism for use in generating multicloud deployments with a focus on environmental sustainability of the deployments.

An example system can comprise at least one processor; and at least one memory that stores executable instructions that, when executed by the at least one processor, facilitate performance of operations, comprising: obtaining specified environmental sustainability criteria corresponding to environmental sustainability of cloud computing; and based on the environmental sustainability criteria, generating a deployment plan for cloud computing equipment of a cloud computing network that performs cloud computing, wherein the deployment plan comprises at least one configuration factor that defines operation of the cloud computing equipment to satisfy the environmental sustainability criteria.

An example method can comprise identifying, by a system operatively coupled to at least one processor, a change to use of a first cloud computing system; and based on the identifying, generating a deployment plan applicable to cloud computing at the first cloud computing system or at a second cloud computing system, wherein the deployment plan comprises configuration factors that define operation of the first cloud computing system or the second cloud computing system to satisfy specified environmental sustainability criteria.

An example non-transitory computer-readable medium can comprise executable instructions that, when executed by a processor, can facilitate performance of operations. The operations can comprise based on historical data corresponding to historical sustainability results associated with a cloud computing system, generating a first deployment plan for the cloud computing system, wherein the first deployment plan comprises configuration factors that define operation of the cloud computing system to satisfy environmental sustainability criteria, and modifying the first deployment plan to generate a modified deployment plan based on a second sustainability importance rating that is different from a first sustainability importance rating associated with the first deployment plan.

An example benefit of one or more of the above-indicated method, system and/or non-transitory computer-readable medium can be an ability to provide flexible decision-making information to a user entity of the cloud computing equipment, such as an administrating entity. This information can be flexible because it can be obtained and/or provided before making a decision and further at a specified frequency after making a decision, thus allowing for dynamic changes (e.g., additional decisions as to cloud networking equipment). The information can include sustainability scores, criticality levels of particular sustainability criteria, cloud computing equipment operating parameters applicable to the sustainability score, etc.

The dynamic nature of the one or more embodiments described herein can be provided by automatically generating and/or obtaining a notification of a change of an operating parameter of cloud networking equipment being employed or of a change to a key performance indicator being monitored either on the provider-end (e.g., provider of the cloud networking system) and/or at the user-end (e.g., user entity of the cloud networking system).

Furthermore, in one or more embodiments, the above-indicated method, system and/or non-transitory computer-readable medium can function relative to multi-cloud deployment, and/or with any combination of private cloud equipment/systems and/or public cloud equipment/systems.

Another example benefit of one or more of the above-indicated method, system and/or non-transitory computer-readable medium can be an ability to provide automatic deployment plan generation based on receipt of a notification and/or upon triggering of the deployment plan generation. Such notification can be sent based on change of scale of use of the cloud networking system, change in an operation parameter of the cloud networking system, and/or change in a sustainability level applicable to the cloud networking system. Additionally, and/or alternatively, such notification can be sent based on any one or more of these noted factors relative to a different cloud networking system not being used, but perhaps being evaluated for a future deployment. Such triggering can be provided automatically and/or based on user entity input.

### BRIEF DESCRIPTION OF THE DRAWINGS

The technology described herein is illustrated by way of example and not limited to the accompanying figures in which like reference numerals indicate similar elements.

FIG. 1 illustrates a block diagram of an example, non-limiting system that can provide a process to generate a sustainability-based deployment plan, in accordance with one or more embodiments described herein.

FIG. 2 illustrates a block diagram of another example, non-limiting system that can provide a process to generate a sustainability-based deployment plan, in accordance with one or more embodiments described herein.

FIG. 3 illustrates a high-level flow diagram of a set of exemplary processes that can be performed by the non-limiting system of FIG. 2, in accordance with one or more embodiments described herein.

FIG. 4 illustrates a flow diagram of a deployment plan generation triggering process that can be performed by the non-limiting system of FIG. 2, in accordance with one or more embodiments and/or implementations described herein.

FIG. 5 illustrates a schematic diagram of a deployment plan generation configuration 500 that can be generated and/or employed by the non-limiting system of FIG. 2, in accordance with one or more embodiments and/or implementations described herein.

FIG. 6 illustrates a flow diagram of a deployment plan implementation process that can be performed by the non-limiting system of FIG. 2, in accordance with one or more embodiments and/or implementations described herein.

FIG. 7 illustrates a flow diagram of a deployment plan re-triggering process that can be performed by the non-limiting system of FIG. 2, in accordance with one or more embodiments and/or implementations described herein.

FIG. 8 illustrates a process flow diagram of a method of sustainability-based deployment plan generation for cloud computing, in accordance with one or more embodiments and/or implementations described herein.

FIG. 9 illustrates a continuation of the process flow diagram of FIG. 8 of the method of sustainability-based deployment plan generation for cloud computing, in accordance with one or more embodiments and/or implementations described herein.

FIG. 10 illustrates a continuation of the process flow diagram of FIG. 9 of the method of sustainability-based deployment plan generation for cloud computing, in accordance with one or more embodiments and/or implementations described herein.

FIG. 11 illustrates a process flow diagram of a method of sustainability-based deployment plan generation for cloud computing, in accordance with one or more embodiments and/or implementations described herein.

FIG. 12 illustrates a continuation of the process flow diagram of FIG. 11 of the method of sustainability-based deployment plan generation for cloud computing, in accordance with one or more embodiments and/or implementations described herein.

FIG. 13 illustrates a process flow diagram of a method of sustainability-based deployment plan generation for cloud computing, in accordance with one or more embodiments and/or implementations described herein.

FIG. 14 illustrates a continuation of the process flow diagram of FIG. 13 of the method of sustainability-based deployment plan generation for cloud computing, in accordance with one or more embodiments and/or implementations described herein.

FIG. 15 illustrates a block diagram of an example operating environment into which embodiments of the subject matter described herein can be incorporated.

FIG. 16 illustrates an example schematic block diagram of a computing environment with which the subject matter described herein can interact and/or be implemented at least in part.

### DETAILED DESCRIPTION

### Overview

The technology described herein is generally directed towards systems, methods and/or computer program products for facilitating selection of a cloud computing system or cloud computing deployment by providing generation of an environmental sustainability-based cloud computing deployment plan.

As alluded to above, commitment to environmental sustainability continues to increase as a focus or consideration of importance related to various aspects of computing system selection, setup, configuration, and/or the like. In combination therewith, cloud computing also continues to increase as an integral aspect of businesses ranges from small single employee side hustles to large multi-employee corporations. Businesses of all sizes continue to recognize their impact on the environment and strive to employ an environmentally sustainable approach to business of varying types and sizes. One way in which this impact can be minimized is through environmentally-conscious decisions relative to cloud computing services, whether being private cloud services and/or public cloud services. By adopting sustainable cloud deployment practices, a carbon footprint of a business, or of any other cloud computing use, can be reduced.

An existing approach for environmentally-sustainable cloud computing deployments can be to employ reactive analysis of various aspects corresponding to cloud computing equipment. These aspects can comprise effect of the cloud deployment on a set of environmental sustainability factors based on analysis of use of the cloud computing equipment over time. As indicated, this approach is reactive only and does not account for determining environmental sustainability of a cloud deployment prior to the deployment. That is, existing approaches cannot allow for any decision to be made proactively relative to choosing to use one cloud computing system over another (e.g., first cloud computing equipment over second cloud computing equipment).

Accordingly, it can be difficult, cumbersome or even impossible to change cloud deployments after day 0 of a cloud deployment has occurred. Further, any decision to select an alternative cloud deployment would again be made absent any proactive understanding of the alternative cloud computing system to be selected. Moreover, if the initially selected cloud computing system provides low environmental sustainability, this may not be realized until long after initial deployment, resulting in a lack of reduction of carbon footprint or other environmental benefits from its use. Also in connection therewith, dynamic adjustment of deployment plans is prevented in view of lack of proactive environmental sustainability-based input related to cloud computing.

In view of the above, it can therefore be desired to provide a system and/or method for generating proactive input allowing for initial selection of a cloud computing system based on a generated cloud deployment plan. It also can be desired to provide a system and/or method for dynamically gathering information to provide a dynamically adjusted cloud deployment plan at a suitable frequency and/or on demand.

To account for one or more deficiencies of existing approaches, described herein are one or more embodiments that can employ input information including a set of sustainability criteria, performance indicators, and/or historical sustainability factors (e.g., results of operation of a cloud computing system comprising cloud computing equipment) to proactively generate a cloud deployment plan. Such cloud deployment plan can be generated at any frequency and such plan can be updated at a suitable frequency based on continued feedback regarding the input information. In one or more embodiments, a cloud computing deployment can be decided and/or otherwise selected based on such cloud deployment plan. In one or more embodiments, a cloud deployment plan can be employed to direct a change to use of and/or operation of a cloud computing system.

That is, by proactively gathering, analyzing and make one or more decisions based upon sustainability criteria related to environmental sustainability of a cloud computing system, not only can decisions be made prior to day 0 operations, but operations at the user-entity side, interfacing with a cloud computing system, can be optimized, allowing for a user entity's computing architecture to be self-improving. Overall, such tools can constitute a concrete and tangible technical and/or physical improvement in the fields of cloud computing and environmentally sustainable computing more generally.

The one or more embodiments described herein can be employed cooperatively with an operation system that comprises one or more computing systems having one or more hardware devices and one or more file systems.

The one or more embodiments described herein can comprise a system that will employ a cloud computing system based on a deployment plan generated herein. Alternatively, in one or more other embodiments, the one or more embodiments described herein can comprise a system that will not employ and/or will not communicate with any cloud computing system based on a deployment plan generated herein.

### Terminology

As used herein, a “cloud computing system” comprises “cloud computing equipment” that can comprise hardware and/or software.

As used herein, the terms “cost” or “expense” can refer to power, memory and/or processing power.

As used herein, the term “data” can comprise “metadata.”

Reference throughout this specification to “embodiment,” “one embodiment,” “an embodiment,” “one implementation,” and/or “an implementation,” means that a feature, structure, or characteristic described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the features, structures, or characteristics may be combined in any suitable manner in one or more embodiments/implementations.

As used herein, the terms “employing” or “employed by” can refer to an element (e.g., a hardware device) that is currently being employed, that has already been employed and/or that is to be employed.

As used herein, the term “entity” can refer to a machine, device, smart device, component, hardware, software and/or human.

A “group of hardware” or “equipment” can refer to a subset of hardware devices of an operation system, which hardware devices can comprise, but are not limited to, storage nodes, switch nodes, server nodes and/or corresponding communication devices, and which operation system can comprise one or more computing systems.

As used herein, with respect to any aforementioned and below mentioned uses, the term “in response to” can refer to any one or more states including, but not limited to: at the same time as, at least partially in parallel with, at least partially subsequent to and/or fully subsequent to, where suitable.

As used herein, the term “power” can refer to electrical and/or other source of power available to the operation system.

As used herein, the term “resource” can refer to power, money, memory, CPU bandwidth, processing power, labor, hardware and/or software.

As used herein, the term “set” can refer to one or more.

### Example Architectures

One or more embodiments are now described with reference to the drawings, where like referenced numerals are used to refer to like elements throughout. In the following description, for purposes of explanation, numerous specific details are set forth to provide a more thorough understanding of the one or more embodiments. It is evident, however, in various cases, that the one or more embodiments can be practiced without these specific details.

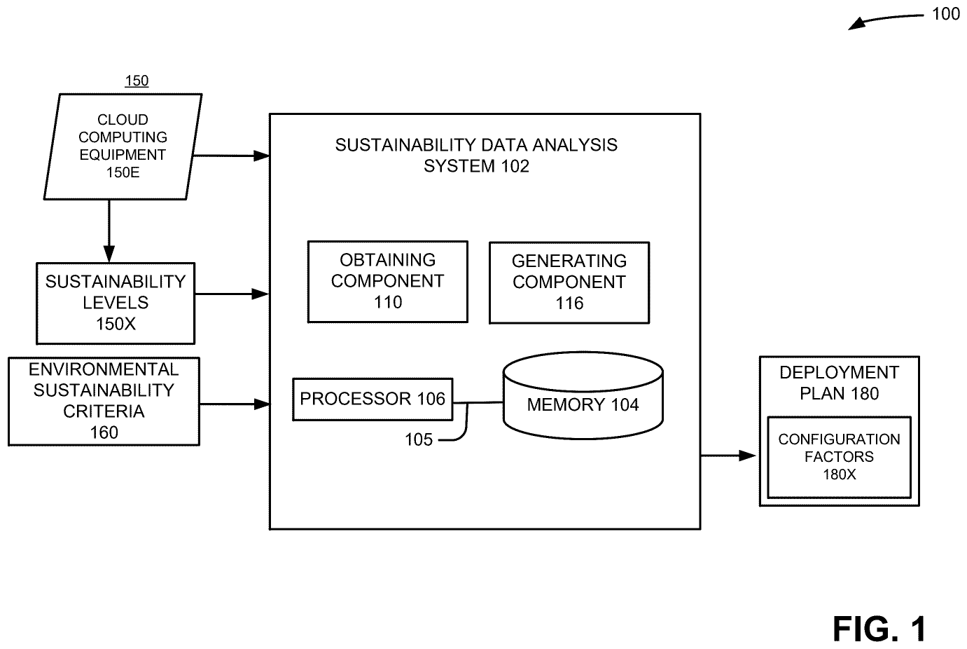

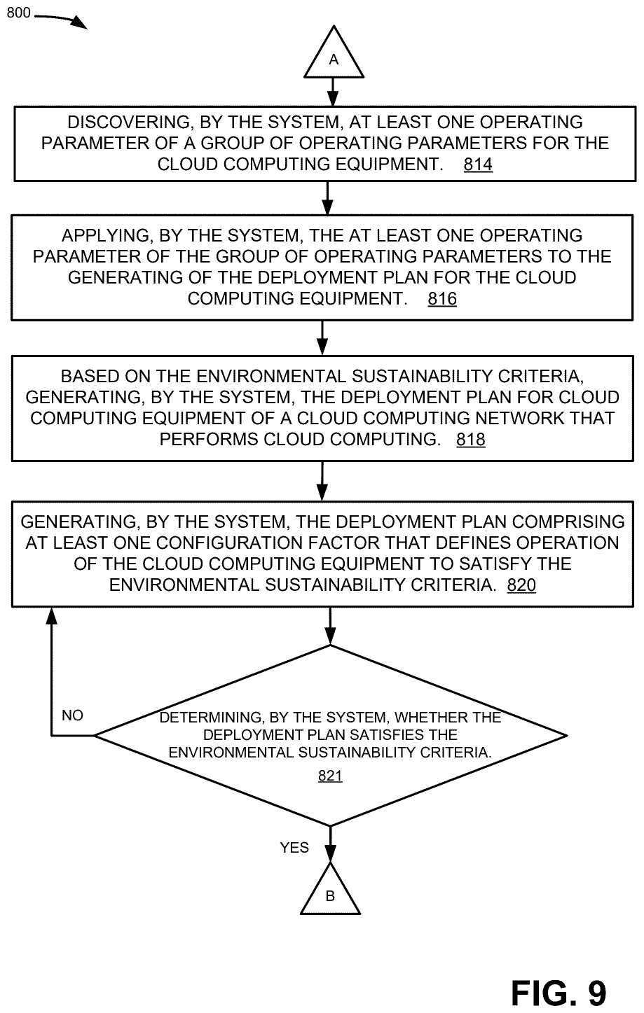

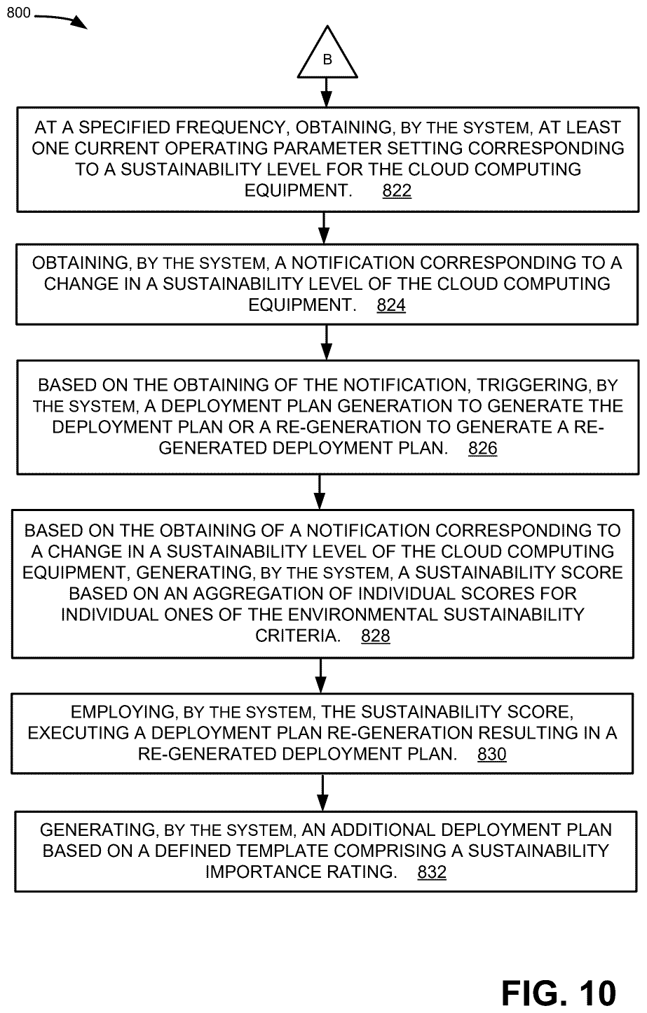

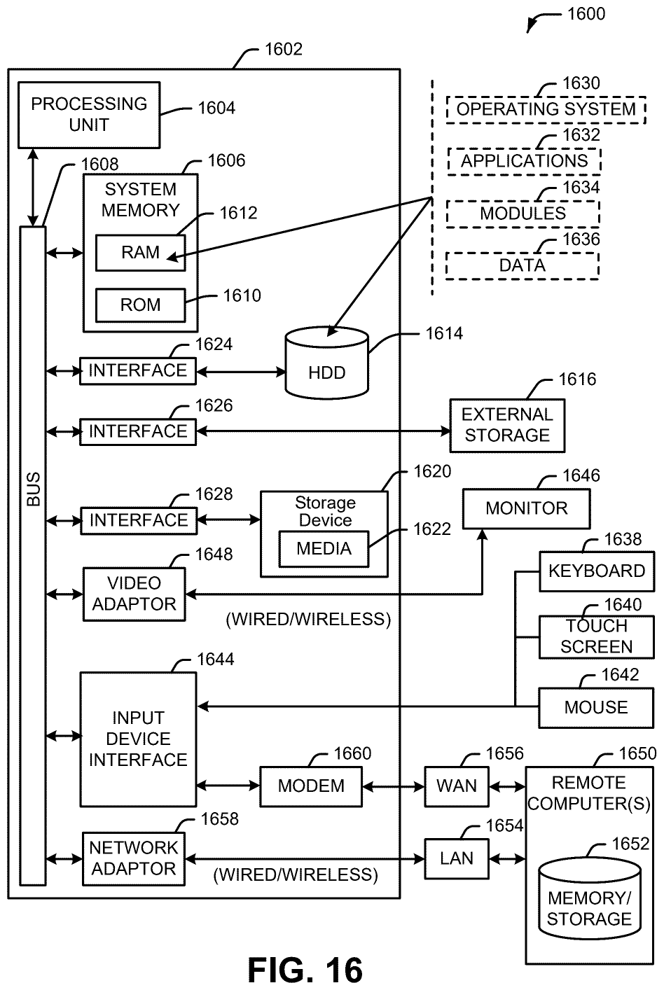

Further, the embodiments depicted in one or more figures described herein are for illustration only, and as such, the architecture of embodiments is not limited to the systems, devices and/or components depicted therein, nor to any order, connection and/or coupling of systems, devices and/or components depicted therein. For example, in one or more embodiments, the non-limiting system architectures described, and/or systems thereof, can further comprise one or more computer and/or computing-based elements described herein with reference to an operating environment, such as the operating environment 1600 illustrated at FIG. 16. In one or more described embodiments, computer and/or computing-based elements can be used in connection with implementing one or more of the systems, devices, components and/or computer-implemented operations shown and/or described in connection with FIGS. 1-13 and/or with other figures described herein.

Turning now in particular to one or more figures, and first to FIG. 1, the figure illustrates a block diagram of an example, non-limiting system 100 that can facilitate environmental sustainability-driven decision making relative to deployment at a cloud computing instance, such as at a multicloud comprising one or more cloud computing instances. A cloud computing instance can be supported by a cloud computing system 150 that can support one or more cloud computing instances. A cloud computing system 150 can comprise cloud computing equipment 150E, which can comprise hardware and/or software. The decision making can be based on generation, by the one or more embodiments described herein, of a cloud computing deployment plan 160 (also herein referred to as a deployment plan) that describes a sustainability level 150X of a cloud computing system 150 based on a plurality of one or more environmental sustainability criteria 160. Generally, based on a system of scoring using weights, the deployment plan 180 can be generated prior to implementing a cloud computing instance. This can allow for proactive decision making relative to choosing a cloud computing system, type and/or provider entity, at least partially based on the environmental impact of the cloud computing system to be selected.

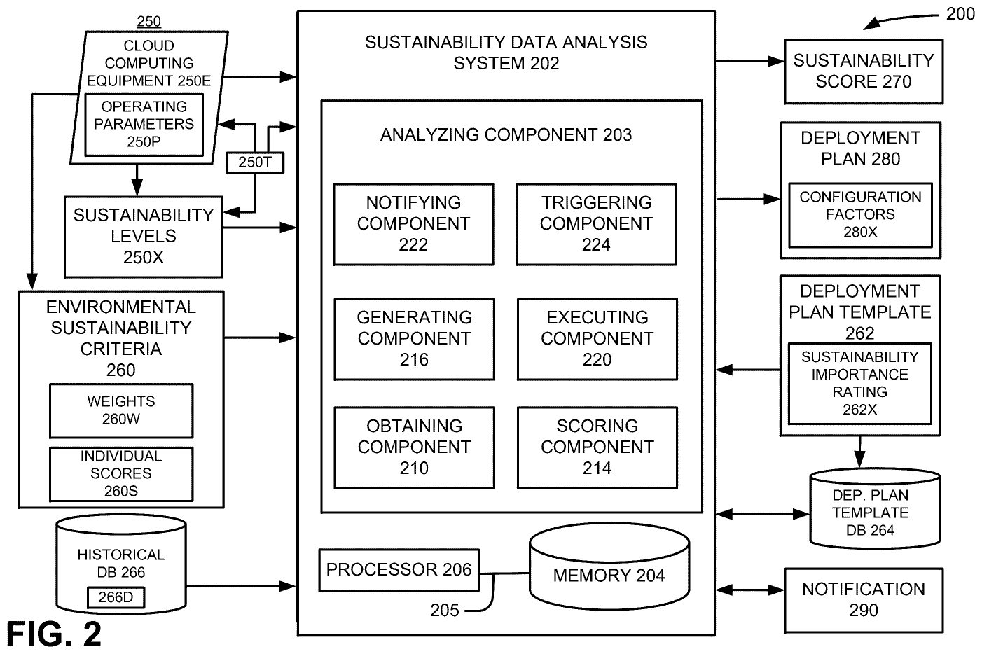

The non-limiting system 100 can comprise a sustainability data analysis system 102 and a cloud computing system 150, although the cloud computing system 150 can be omitted and be external to the non-limiting system 100 in one or more embodiments. It is noted that the sustainability data analysis system 102 is only briefly detailed to provide but a lead-in to a more complex and/or more expansive sustainability data analysis system 202 as illustrated at FIG. 2. That is, further detail regarding processes performed by one or more embodiments described herein will be provided below relative to the non-limiting system 200 of FIG. 2.

Still referring to FIG. 1, the sustainability data analysis system 102 can comprise at least a memory 104, bus 105, processor 106 of a processor set of one or more processors, an obtaining component 110 and/or a generating component 116. Using these elements, the sustainability data analysis system 102 can generate the deployment plan 180 to at least partially respond to a request to implement a cloud computing instance at a cloud computing equipment, such as the cloud computing equipment 150E or other cloud computing equipment.

The obtaining component 110 generally can obtain one or more environmental sustainability criteria 160 having been specified by a user entity that requires, desires and/or otherwise requests use of a cloud computing system, such as the cloud computing system 150 which will be selected based on the processes performed by the sustainability data analysis system 102.

The generating component 116 generally can generate, based on the environmental sustainability criteria 160, a deployment plan 180 for cloud computing equipment 180E of a cloud computing network that performs cloud computing. That is, the deployment plan 180 is specific to a particular cloud computing system 150, although in one or more other embodiments, a deployment plan 180 can specify options of two or more cloud computing systems 150 or even of different cloud computing equipment 150E of a same or different cloud computing systems 150. The generated deployment plan 180 comprises at least one configuration factor 180X that defines operation of the cloud computing equipment 180E to satisfy the environmental sustainability criteria 160. For example, the configuration factors 180X can comprise one or more operating parameters, use parameters (e.g., specifying use by the user entity) and/or the like guiding the employment of a cloud computing equipment 180E referred to in the deployment plan 180.

In one or more embodiments, the obtaining component 110 and/or generating component 116 can be operatively coupled to a processor 106, of a processor set of one or more processors, one or more of which are operatively coupled to a memory 104. The bus 105 can provide for the operative coupling. The processor 106 can facilitate execution of the obtaining component 110 and/or generating component 116. In one or more embodiments, the obtaining component 110 and/or generating component 116 can be stored at the processor 106 and/or at any processor of the processor set, together or separately from one another.

In general, the non-limiting system 100 can employ any suitable method of communication (e.g., electronic, communicative, internet, infrared, fiber, etc.) to provide communication between the sustainability data analysis system 102 and a cloud computing system 150.

Turning next to FIG. 2, the figure illustrates a block diagram of an example, non-limiting system 200 that can facilitate environmental sustainability-driven decision making relative to deployment at a cloud computing instance, such as at a multicloud comprising one or more cloud computing instances. A cloud computing instance can be supported by a cloud computing system 250 that can support one or more cloud computing instances. A cloud computing system 250 can comprise cloud computing equipment 250E, which can comprise hardware and/or software. The decision making can be based on generation, by the one or more embodiments described herein, of a cloud computing deployment plan 280 (also herein referred to as a deployment plan) that describes a sustainability level 250X of a cloud computing system 250 based on a plurality of one or more environmental sustainability criteria 260. Generally, based on a system of scoring using weights, the deployment plan 280 can be generated prior to implementing a cloud computing instance. This can allow for proactive decision making relative to choosing a cloud computing system, type and/or provider entity, at least partially based on the environmental impact of the cloud computing system to be selected.

FIG. 2 illustrates non-limiting system 200 comprising a sustainability data analysis system 202 that can function to generate, based on the environmental sustainability criteria 260, a deployment plan 280 for cloud computing equipment 280E of a cloud computing network that performs cloud computing. While referring here to one or more processes, operations, facilitations and/or uses of the non-limiting system 200, description provided herein, above and/or below also can be relevant to one or more other non-limiting system architectures described herein (e.g., of FIG. 1). Repetitive description of like elements and/or processes employed in respective embodiments is omitted for sake of brevity.

Generally, the sustainability data analysis system 202 can comprise any suitable computing devices, hardware, software, operating systems, drivers, network interfaces and/or so forth. As illustrated, the sustainability data analysis system 202 can comprise obtaining component 210, scoring component 214, generating component 216, executing component 220, notifying component 222 and/or triggering component 224. These components can be comprised by a processor 204 and/or one or more of these components can be external to the processor 204. A bus 205 can operatively couple the processor 204 and a memory 206.

Communication among the components of the sustainability data analysis system 202 can be by any suitable method. Communication can be facilitated by wired and/or wireless methods including, but not limited to, employing a cellular network, a WAN (e.g., the Internet), and/or a LAN. Suitable wired or wireless technologies for facilitating the communications can include, without being limited to, Wi-Fi, GSM, UMTS, WiMAX, enhanced GPRS, 3GPPLTE, 3GPP2UMB, HSPA, ZIGBEE® and other 802.XX wireless technologies and/or legacy telecommunication technologies, BLUETOOTH®, SIP, RF4CE protocol, WirelessHART protocol, 6LoWPAN, Z-Wave, an ANT protocol, a UWB standard/protocol and/or other proprietary and/or non-proprietary communication protocols.

Discussion first turns to the processor 204, memory 206 and bus 205 of the sustainability data analysis system 202.

In one or more embodiments, the sustainability data analysis system 202 can comprise a processor 204 (e.g., computer processing unit, microprocessor, classical processor and/or like processor). In one or more embodiments, the processor 204 can be and/or be comprised by a controller.

In one or more embodiments, a component (which also can be referred to as a module) associated with sustainability data analysis system 202, as described herein with or without reference to the one or more figures of the one or more embodiments, can comprise one or more computer and/or machine readable, writable and/or executable components and/or instructions that can be executed by processor 204 to facilitate performance of one or more processes defined by such component and/or instruction.

In one or more embodiments, the sustainability data analysis system 202 can comprise a machine-readable memory 206 that can be operably connected to the processor 204. The memory 206 can store computer-executable instructions that, upon execution by the processor 204, can cause the processor 204 and/or one or more other components of the sustainability data analysis system 202 to perform one or more actions. In one or more embodiments, the memory 206 can store computer-executable components.

The sustainability data analysis system 202 and/or a component thereof as described herein, can be communicatively, electrically, operatively, optically and/or otherwise coupled to one another via a bus 205 to perform functions of non-limiting system architecture 200, sustainability data analysis system 202 and/or one or more components thereof and/or coupled therewith. Bus 205 can comprise one or more of a memory bus, memory controller, peripheral bus, external bus, local bus and/or another type of bus that can employ one or more bus architectures. One or more of these examples of bus 205 can be employed to implement one or more embodiments described herein.

In one or more embodiments, sustainability data analysis system 202 can be coupled (e.g., communicatively, electrically, operatively, optically and/or like function) to one or more external systems (e.g., a system management application), sources and/or devices (e.g., classical communication devices and/or like devices), such as via a network. In one or more embodiments, one or more of the components of the sustainability data analysis system 202 can reside in the cloud, and/or can reside locally in a local computing environment (e.g., at a specified location).

In addition to the processor 204 and/or memory 206 described above, the sustainability data analysis system 202 can comprise one or more computer and/or machine readable, writable and/or executable components and/or instructions that, when executed by processor 204, can facilitate performance of one or more operations defined by such component and/or instruction.

It is noted that in one or more embodiments, the obtaining component 210, scoring component 214, generating component 216, executing component 220, notifying component 222 and/or triggering component 224 are implemented independently, without one or more other of the obtaining component 210, scoring component 214, generating component 216, executing component 220, notifying component 222 and/or triggering component 224. Additionally and/or alternatively, the obtaining component 210, scoring component 214, generating component 216, executing component 220, notifying component 222 and/or triggering component 224 are comprised by a high-level analyzing component 203, one or more of the below-described functions of the obtaining component 210, scoring component 214, generating component 216, executing component 220, notifying component 222 and/or triggering component 224 are performed by the high-level analyzing component 203, and/or the obtaining component 210, scoring component 214, generating component 216, executing component 220, notifying component 222 and/or triggering component 224 are omitted with the high-level analyzing component 203 performing one or more of the below-described functions of the one or more omitted obtaining component 210, scoring component 214, generating component 216, executing component 220, notifying component 222 and/or triggering component 224.

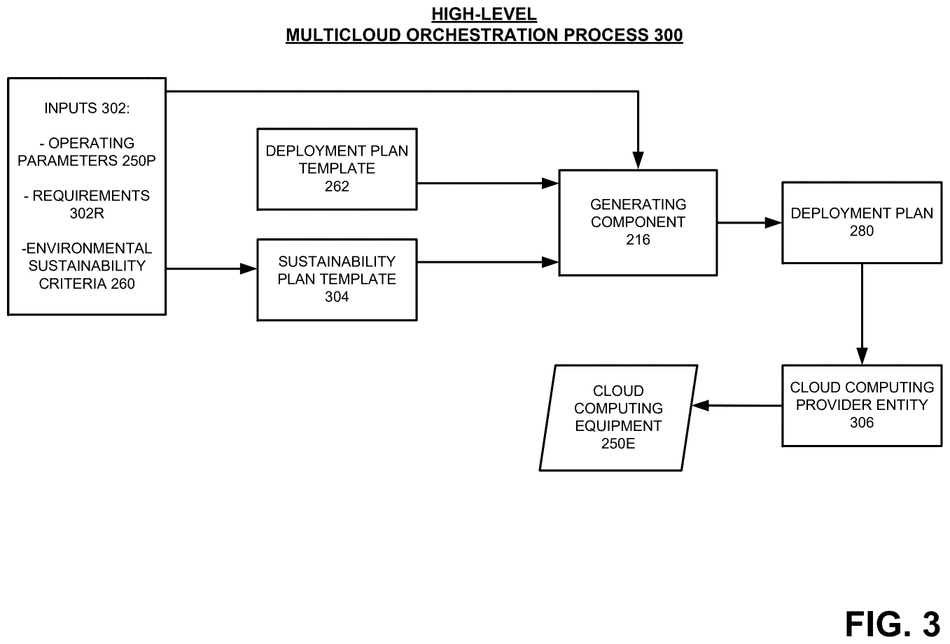

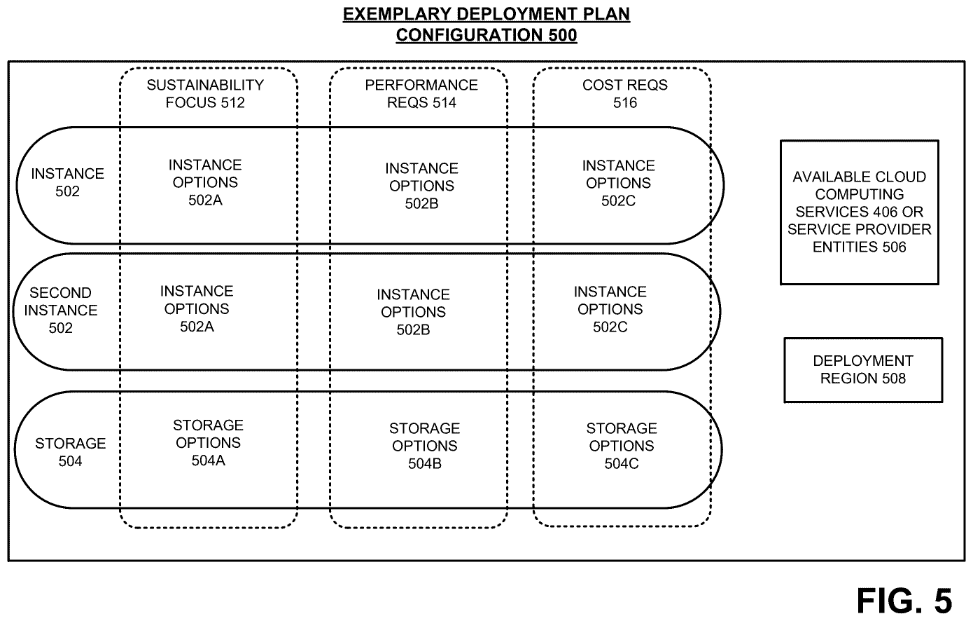

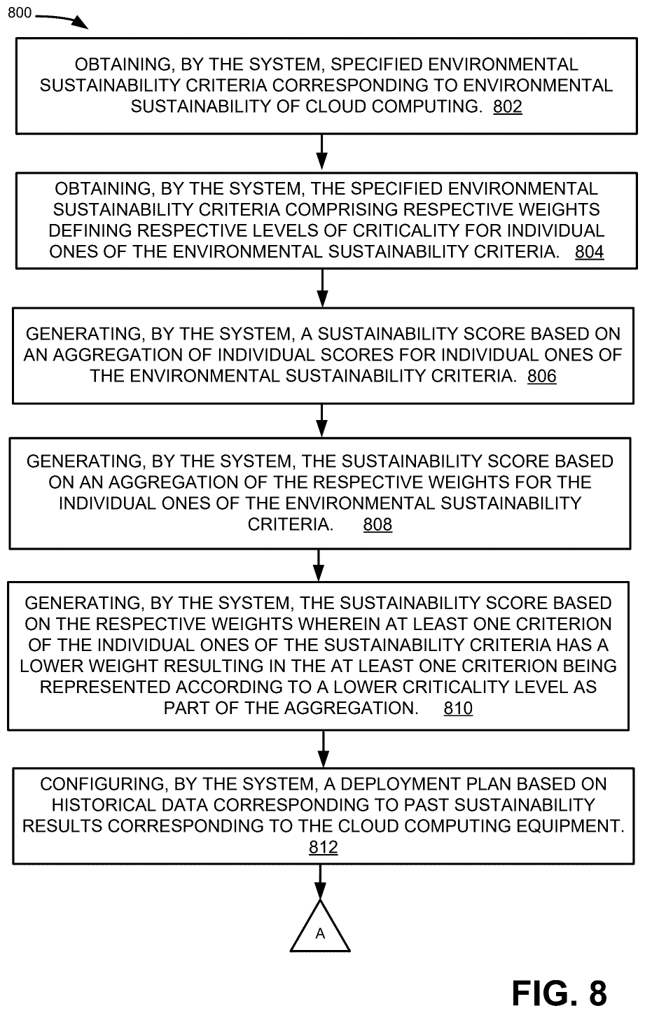

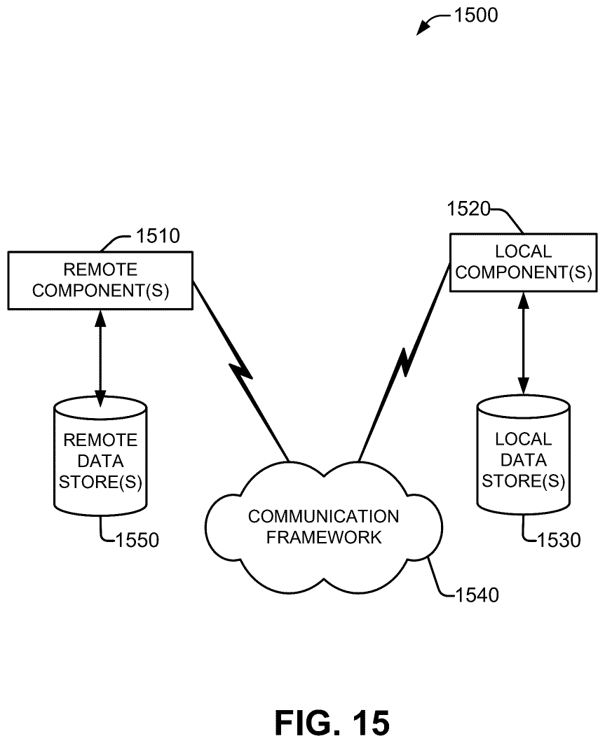

Direction next first turns to a general, high-level set of processes 300, illustrated at FIG. 3, for multicloud orchestration, while still referring to one or more aspects of FIG. 2. FIGS. 5-7 will then be described with each of the components of FIG. 2 being detailed. Thereafter, flow diagrams of FIGS. 8-14 will be detailed, followed by the example operating environment and example computing environment of FIGS. 15 and 16, respectively.

Accordingly, looking to FIG. 3, and also still continuously to FIG. 2, the multicloud orchestration process 300 is so called because the one or more embodiments described herein can provide a deployment plan setting forth information defining environmental sustainability information for implementation of one or more cloud computing instances of one or more types (e.g., public and/or private cloud computing systems).

As shown at the process 300, inputs 302 can be employed to generate a deployment plan 280. The inputs 302 can comprise operating parameters 250P, requirements 302R, and/or environmental sustainability criteria 260 relative to an ideal cloud computing system. The requirements 302R can comprise performance requirements 514 and/or cost requirements 516, for example.

The available cloud computing services 406 can have associated therewith one or more of the cloud computing systems 250 that comprise cloud computing equipment 250E, that in turn comprise hardware and/or software. Based on evaluation of operating parameters 250P and/or various key performance indicators (KPIs) 250K, a sustainability level 250X can be assigned to a cloud computing system 250, to be explained below.

The sustainability level 250X can be based on a threshold level of satisfaction 250T for the respective cloud computing system 250 of various environmental sustainability criteria 260.

The environmental sustainability criteria 260 can comprise default options and/or be specified, such as by a user entity of the sustainability data analysis system 202 or a future user entity of a cloud computing instance to be selected.

Relative to the sustainability level 250X of an available cloud computing system 250, the operating parameters 250P and/or KPIs 250K of the cloud computing system 250 can be compared to the environmental sustainability criteria 260. A rating system of any suitable type can be employed to determine whether one or more of the environmental sustainability criteria 260 are met by a respective cloud computing system 250. For example, in one non-limiting embodiment, one environmental sustainability criterion 260 can be 50% met and another environmental sustainability criteria 260 can be 990% met by a respective cloud computing system 250. Different threshold levels of satisfaction 250T for different environmental sustainability criteria 260 can be employed, and/or one threshold level of satisfaction 250T can be employed for two or more environmental sustainability criteria 260. Use of a single threshold level of satisfaction 250T and/or an aggregation of one or more threshold levels of satisfaction 250T can result in output of a respective sustainability level 250X. The correlation between the sustainability level 250X and the one or more threshold levels of satisfaction 250T can be 1:1 (e.g., 50% aggregated threshold met results in a sustainability level 250X of 50%) or any other suitable correlation can be employed.

Relative to generation of a deployment plan 280 for an ideal cloud computing system, it is noted that the environmental sustainability criteria 260 can be analyzed in greater detail. That is, the environmental sustainability criteria 260 can comprise individual criterion having individual scores 260S associated therewith. In one or more embodiments, an individual score 260S, and thus an individual criterion, can be weighted using a weight 260W, which weight 260W can allow for dynamic control of a sustainability score 270 to be output by the sustainability data analysis system 202.

That is, the sustainability score 270 can comprise an aggregation of individual scores 260S of a group of environmental sustainability criteria 260 applicable to an ideal cloud computing system 250. One or more weights 260W can be applied to the individual scores 260S to otherwise adjust the aggregation of the individual score 260S, thus affecting the resulting sustainability score 270. Further, a sustainability plan template 304 can be output including listing the various environmental sustainability criteria 260, individual scores 260S, individual weights 260W and sustainability scores 270. In one or more cases, different environmental sustainability criteria 260 can be grouped resulting in different sustainability scores, and thus a sustainability plan template 304 can comprise two or more sustainability score options with associated details (e.g., the associated environmental sustainability criteria 260, individual scores 260S, and/or individual weights 260W).

Using the sustainability plan template 304, and also using a deployment plan template 262, a deployment plan 280 can be generated. The deployment plan template 262 can comprise an ideal layout of sustainability score 270, performance requirements 514 and/or cost requirements 516. In one or more embodiments, a deployment plant template 262 can have a sustainability importance rating 262X that specifies an importance, or associated weight, of sustainability focus as compared to performance focus and/or cost focus. That is, the deployment plan template 262 can provide a layout for a compromise between sustainability score 270, performance requirements 514 and/or cost requirements 516, as it is often that all three of sustainability score 270, performance requirements 514 and/or cost requirements 516 cannot each be fully met in an available, or even possible, cloud computing system 250. Accordingly, the deployment plan template 262 and/or the sustainability plan template 304 are not meant to be limiting, and thus are employed as guiding inputs to the deployment plan 280. That is, the deployment plan 280 can deviate from the deployment plan template 262 and/or the sustainability plan template 304.

The output deployment plan 280, to be discussed in detail below relative to FIG. 5, can have one or more configuration factors 280X associated with the deployment plan 280. That is, the configuration factors 280X can specify proposed operating parameters 250P and/or use limitations of a cloud computing system to be chosen, where application of and/or following the configuration factors 280X by a user entity of a selected cloud computing system 250 can allow for satisfying one or more of the environmental sustainability criteria 260 upon which the deployment plan 280 is based. For example, in one or more embodiments, one or more operating parameters 250P can be requested by a user entity to a cloud computing provider entity 506 that provides a cloud computing service and/or cloud computing system 250. For another example, in one or more embodiments, a scale of use by a user entity of a cloud computing system 250 can be suggested as a configuration factor 280X.

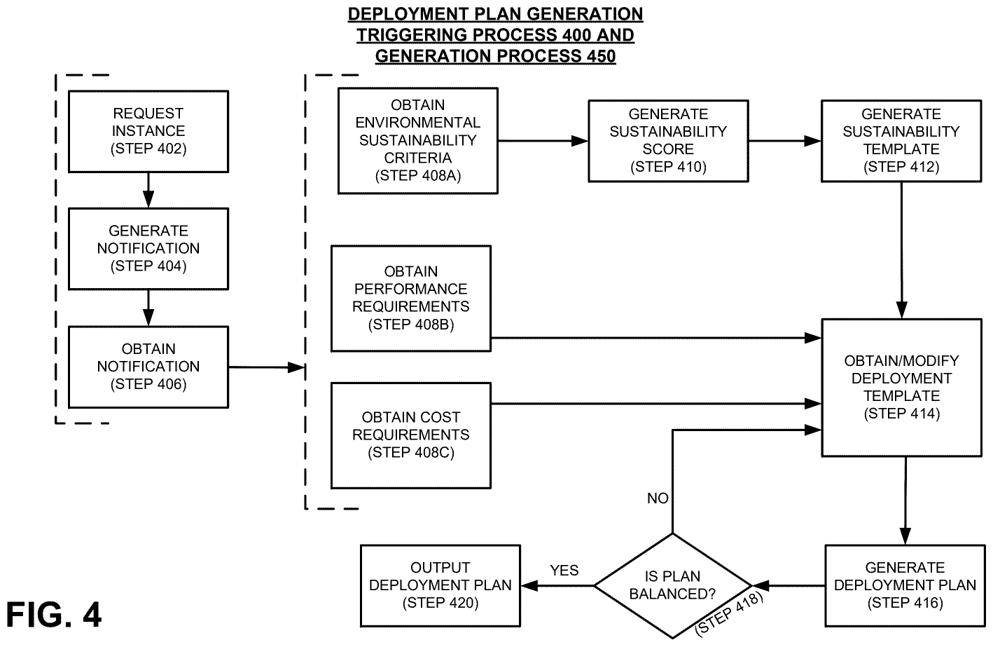

Turning now to FIG. 4, and still to continuously to FIG. 2, the sustainability data analysis system 202 can be employed for notifying of a need for a deployment plan generation 450 and/or for triggering (e.g., triggering process 400) a deployment plan generation 450. For example, a user entity and/or the sustainability data analysis system 202 (e.g., obtaining component 210) can submit a request for a new instance of cloud computing to be employed (e.g., step 402). For example, this request can be generated based on a communication from a current cloud computing service provider entity 506 of a change in operating parameter, such as that affects and/or is linked to (e.g., by associated metadata) one or more environmental sustainability criteria 260 to be described in detail below. Additionally, and/or alternatively, this request can be generated based on a communication from a current cloud computing service provider entity 506 and/or from a user entity of a change in use (e.g., scale of use, frequency of use, volume of use, etc.) of a cloud computing system (or datacenter) currently in use by the user entity or one or more other customer entities of the current cloud computing service provider entity 506. The one or more communications can be obtained (e.g., gather, identify, discover, find, locate, receive, request and/or otherwise obtain) by the obtaining component 210 using any suitable method of communication.

In response to obtaining the communication, the notifying component 222 can notify of a change counter to a deployment plan 280 or other pre-day 0 environmental sustainability protocol, currently being employed. For example, the notifying component 222 can generate a notification 290 (e.g., step 404) and/or send a notification 290 to the non-limiting system 200 and/or to the sustainability data analysis system 202 providing information defining the change.

In one or more embodiments the notification 290 can first be sent to a user entity that can execute the triggering process 400 of the triggering component 224 using a computing device associated with the user entity and communicatively couplable to the non-limiting system 200 and/or to the sustainability data analysis system 202

In response to receipt of a notification 290 (e.g., step 406) or the user entity feedback, the triggering component 224 can trigger the generation process 450, such as by communicating with the generating component 216 and/or sustainability data analysis system 202 more generally (this is because the obtaining component 210 and/or scoring component 214 can perform one or more operations that can be employed as inputs to the generating component 216 and generation process 450).

It is noted that in one or more embodiments, obtaining of a communication, generating of a request, notifying of a change counter to a deployment plan 280/environmental sustainability protocol, and/or triggering of a deployment plan generation can be performed external to the non-limiting system 200 and/or external to the sustainability data analysis system 202.

Accordingly, in view of the above, the obtaining component 210 also can obtain (e.g., gather, identify, discover, find, locate, receive, request and/or otherwise obtain) one or more additional aspects of information separate from and/or in response to the triggering of the generation process 450 for a deployment plan 280.

For example, the obtaining component 210 can gather, identify, discover, find, locate, receive, request and/or otherwise obtain various aspects discussed above that are employed as inputs to the sustainability plan template 304, deployment plan template 262, and/or deployment plan 280. These various aspects can relate to steps 408A-408C.

For example, the obtaining component 210 can obtain one or more default and/or specified performance requirements (reqs) 514 and/or cost requirements (reqs) 516 applicable to implementation of and/or use of a cloud computing instance 502 (e.g., steps 408B and 408C). Performance requirements 514 can comprise operating bandwidth, memory and/or the like, without being limited thereto. Cost requirements 516 can comprise implementation cost, maintenance costs, service cost, cost of customer service and/or cost of equipment (associated with and/or to facilitate cloud computing usage) to employ at the user entity end, without being limited thereto.

In one or more embodiments, the obtaining component 210 can obtain specified environmental sustainability criteria 260 corresponding to environmental sustainability of cloud computing (e.g., step 408A). These environmental sustainability criteria can be a group of one or more default environmental sustainability criteria 260 and/or can comprise a group of one or more environmental sustainability criteria 260 that have been specified (e.g., requested and/or identified) by a user entity of cloud computing. In the latter case, the group of one or more environmental sustainability criteria 260 can be obtained by communicative coupling (e.g., any suitable method of communication) with a computing device associated with the user entity.

In one or more embodiments, the environmental sustainability criteria 260 can comprise one or more of renewable energy, energy consumption, cooling efficiency, sustainable procurement, waste reduction and/or emission reduction initiatives.

Renewable energy can refer to use of non-renewable resources as opposed to all fossil fuels. For example, a cloud computing service provider entity 506 can purchase renewable energy credits (RECs) to cover a percentage of their consumption.

Energy consumption can refer to use of energy-efficient cloud computing equipment hardware. This can be important because cloud computing is resource intensive and associated workloads on cloud computing equipment 250E frequently requires constant power and cooling.

Cooling efficiency can refer to use of free cooling techniques (e.g., environmental cooling). This is important because a data center of a cloud computing service provider entity 506 can be instead in a region with a hot and humid climate, requiring continuous mechanical cooling to maintain operational temperatures.

Sustainable procurement can refer to the environmental sustainability of channels through which hardware and/or software employed by and/or at the cloud computing system 250 is obtained. For example, whether truck, train, plane, and/or boat freight is used and/or the type of energy and/or fuel employed.

Waste reduction can refer to whether a cloud computing service provider entity 506 has and/or employs recycling facilities, and/or whether the cloud computing service provider entity 506 is an active participant in waste reduction, including physical and/or e-waste. Waste reduction additionally and/or alternatively can refer to whether decommissioned hardware components are being refurbished and/or repurposed.

Emission reduction initiatives can refer to whether a data center of a cloud computing service provider entity 506 uses energy efficient or outdated power-hungry equipment and/or cooling systems. This can also comprise a general focus on renewable energy adoption and/or tracking of carbon footprint in any way.

In one or more embodiments, one or more specified environmental sustainability criteria 260 can be obtained from a user entity by employing a questionnaire which can be responded to using a computing device associated with the user entity and/or with a cloud computing service provider entity 206. For example, an exemplary questionnaire can provide the following inquiries, without being limited thereto: What is the energy consumption of the servers in the datacenter?; What percentage of customers use a particular datacenter energy source?; Have energy efficient servers been purchased?; What is the energy star rating of hardware being employed?; What is the measured carbon footprint of a data center?; What is the quantity of RECs being purchased per unit of time?

The obtaining component 210 can further obtain historical data 266D, such as from a historical database (db) 266. The historical database 266 can be comprised by and/or be external to the non-limiting system and/or the sustainability data analysis system 202. Any suitable method of communication can be employed relative to the historical database 266. In one or more embodiments, the historical data 266D can comprise past sustainability results corresponding to an available cloud computing service 406.

The obtaining component 210 further can obtain a deployment plan template 262 (e.g., as described above; e.g., step 414), such as from a deployment plan template database (db) 264. The deployment plan template database 264 can be comprised by and/or be external to the non-limiting system and/or the sustainability data analysis system 202. Any suitable method of communication can be employed relative to the deployment plan template database 264.

The obtaining component 210 further can obtain one or more weights 260W that can be applied to the one or more environmental sustainability criteria 260. The one or more weights 260W, like the one or more environmental sustainability criteria 260, can be default and/or specified (e.g., requested and/or identified) by a user entity of cloud computing. In the latter case, one or more weights 260W can be obtained by communicative coupling (e.g., any suitable method of communication) with a computing device associated with the user entity.

Based on the obtaining of the various aspects as discussed above, the scoring component 214 can generally generate a sustainability score 270 (e.g., step 410). For example, in one or more embodiments, the scoring component 214 can aggregate individual scores 260S of one or more of the environmental sustainability criteria 260, can apply one or more of the obtained weights 260W to the one or more individual scores 260S, can aggregate one or more of the obtained weights 260W, and/or the like. For example, generating a sustainability score 270 can comprise applying a respective weight 260W to a respective individual score 260S, resulting in an associated environmental sustainability criterion 260 being represented according to a lower criticality level than another environmental sustainability criterion 260 at the sustainability template 304 and/or sustainability score 270.

In one or more embodiments, the scoring component 214 can generate a sustainability template 304 (e.g., step 412), such as by combining the various individual scores 260S, weights 260W and sustainability scores 270 into a database and/or other suitable format (log, code, matrix, list, etc.) This sustainability template 304 can be prepared in a format usable by a computing system (e.g., by the generating component 216) and/or for viewing by a user entity, such as at a computing display device communicatively couplable and/or comprised by the non-limiting system 200 and/or user entity computing device. It is noted that generation of this sustainability template 304 can be optional, but can provide a method of documenting, record keeping and/or the like relative to pre-deployment plan generating steps.

Attention now turns to one or more exemplary sustainability score generations, such as can be performed by the scoring component 214.

In one example, the following weights 260W can be employed, by default and/or by assignment by the user entity, relative to a group of environmental sustainability criteria 260.

Exemplary weights 260W: renewable energy 9; energy consumption 8; cooling efficiency 7; sustainable procurement 6; waste reduction 5; emission reduction initiatives 9.

For example, these weights can be based on placing importance on selecting regions having higher percentage of renewable energy sources, encouraging use of particular instance types, proposing serverless computing options, exploring options for purchasing RECs, proposing migrating to cloud-native services and/or using intelligent-tiering technologies.

An individual scores 260S can be equal to a criterion value*weight. An overall sustainability score 272/sustainability level 250X can be equal to (criterion value 1*weight 1)+(criterion value 2*weight 2)+ . . . (criterion value n*weight n).

For example, relative to renewable energy, if the user entity/default requests 50% renewable energy, the score can be 50%*9=4.5, for example. This individual score 260S can be applied to generate a sustainability score 272. Also relative to renewable energy, if a cloud computing system 250 employs 50% renewable energy, the score can be 50%*9=4.5, for example. This individual score 260S can be applied to generate a sustainability level 250X.

In one or more other embodiments, different formatting (e.g., percentage) or scaling can be employed for any one or more of the individual scores 260S, weights 260W and/or sustainability scores 270.

In one or more embodiments, the scoring component 214 can generate and/or tag a sustainability level 250X as being associated with a particular cloud computing system 250 and/or cloud computing equipment 250E. For example, as described above, the operating parameters 250P and/or KPIs 250K of the respective cloud computing system 250 can be compared to the environmental sustainability criteria 260, such as by the scoring component 214. A rating system of any suitable type can be employed to determine whether one or more of the environmental sustainability criteria 260 are met by a respective cloud computing system 250. For example, in one non-limiting embodiment, one environmental sustainability criterion 260 can be 50% met and another environmental sustainability criteria 260 can be 90% met by a respective cloud computing system 250. Different threshold levels of satisfaction 250T for different environmental sustainability criteria 260 can be employed, and/or one threshold level of satisfaction 250T can be employed for two or more environmental sustainability criteria 260. Use of a single threshold level of satisfaction 250T and/or an aggregation of one or more threshold levels of satisfaction 250T can result in output of a respective sustainability level 250X. The correlation between the sustainability level 250X and the one or more threshold levels of satisfaction 250T can be 1:1 (e.g., 50% aggregated threshold met results in a sustainability level 250X of 50%) or any other suitable correlation can be employed.

Turning now to FIG. 5, and still to continuously to FIG. 2, the sustainability data analysis system 202 can additionally and/or alternatively be employed for the deployment plan generation 450. For example, using the sustainability plan template 304 and deployment plan template 262, as discussed above, the generating component 216 can generate the deployment plan 280.

First, it is noted that in one or more embodiments, the generating component 216 can modify an obtained deployment plan template 262 (e.g., step 414). This modification can comprise adding and/or deleting one or more elements, information types and/or the like. In one or more embodiments, this modification can comprise tagging a deployment plan template 262 with an associated sustainability importance rating 262X. Such sustainability importance rating 262X (e.g., priority rating) can employ any suitable rating system, such as high, medium and low. In one or more embodiments, a high rating can refer to sustainability focus being more important than either performance and/or cost focus. A medium rating can refer to sustainability focus having some priority over performance and/or cost focus. A low rating can refer to sustainability focus having lower priority than at least one of performance focus and/or cost focus.

To generate the deployment plan 280 (e.g., step 416), the generating component 216 can combine various ones of the aspects discussed above as being generated and/or obtained, such as, but not limited to, one or more sustainability scores 270, environmental sustainability criteria 260, performance requirements 514, cost requirements 516, available cloud computing services 406 and/or cloud computing service provider entities 506, deployment region 508 (e.g., a region of the user entity and/or of the service provider entities 506), and/or the like.

Looking particularly to FIG. 5, illustrated is a schematic drawing of an exemplary configuration 500 of an exemplary deployment plan 280. As illustrated, one or more instances 502 can be suggested in a format that can be displayed to a user entity, such as at a computing display device communicatively couplable and/or comprised by the non-limiting system 200 and/or user entity computing device. For each instance 502, at the sustainability focus 512, one or more instance options can be provided that satisfy or are closest to the sustainability score 272, such as by comparison to the sustainability levels 250X of the respective cloud computing systems 250. An instance option 502A can comprise a particular cloud computing system 250 and/or a particular cloud computing equipment 250E. These cloud computing systems 250 and/or cloud computing equipments 250E can correspond to same and/or different cloud computing service provider entities 506.

For example, in one or more embodiments, the generating component 216 can employ available cloud computing instance options 502A that have higher individual scores 260S or higher sustainability levels 250X.

Additionally, and/or alternatively, for each instance 502, at a performance focus section of the deployment plan 280, one or more instances 502 can be suggested. For each instance 502, at the performance focus section (e.g., corresponding to performance requirements 514), one or more instance options can be provided that satisfy or are closest to the performance requirements 514, such as by comparison to the sustainability levels 250X of the respective cloud computing systems 250. An instance option 502B can comprise a particular cloud computing system 250 and/or a particular cloud computing equipment 250E. These cloud computing systems 250 and/or cloud computing equipments 250E can correspond to same and/or different cloud computing service provider entities 506.

Additionally, and/or alternatively, for each instance 502, at a cost focus section of the deployment plan 280, one or more instances 502 can be suggested. For each instance 502, at the cost focus section (e.g., corresponding to cost requirements 516), one or more instance options can be provided that satisfy or are closest to the cost requirements 516, such as by comparison to the sustainability levels 250X of the respective cloud computing systems 250. An instance option 502C can comprise a particular cloud computing system 250 and/or a particular cloud computing equipment 250E. These cloud computing systems 250 and/or cloud computing equipments 250E can correspond to same and/or different cloud computing service provider entities 506.

Additionally, and/or alternatively, the deployment plan further can provide a line item for one or more storage instances 504. For each storage instance 504, storage options 504A, 504B and 504C can be provided relative to the respective sustainability focus 512, performance focus and cost focus sections.

It is noted that a storage instance can be separate from (e.g., not particularly dictate) a choice of cloud computing instance 502.

Based on the generating, the generating component 216 can further generate one or more of the configuration factors 250X that align with the deployment plan 280. For example, one or more operating parameters 250P and/or use limitations can be determined, such as based on the historical data 266D or any other suitable data.

In one or more embodiments, the generating component 216 can perform a verification step 418 to determine if the deployment plan 280 generated is balanced relative to the environmental sustainability criteria 260 employed as compared to the performance requirements 514 and/or cost requirements 516 employed. For example, a sustainability level 250X of each available or suggested cloud computing instance option 502 can be compared to the sustainability score 270 calculated for the deployment plan 280. A percentage match can be determined and optionally included in the deployment plan 280 for each available or suggested cloud computing instance option 502. In this way, the generating component 216 can at least partially assist in verifying whether the deployment plan 280 satisfies the environmental sustainability criteria 260.

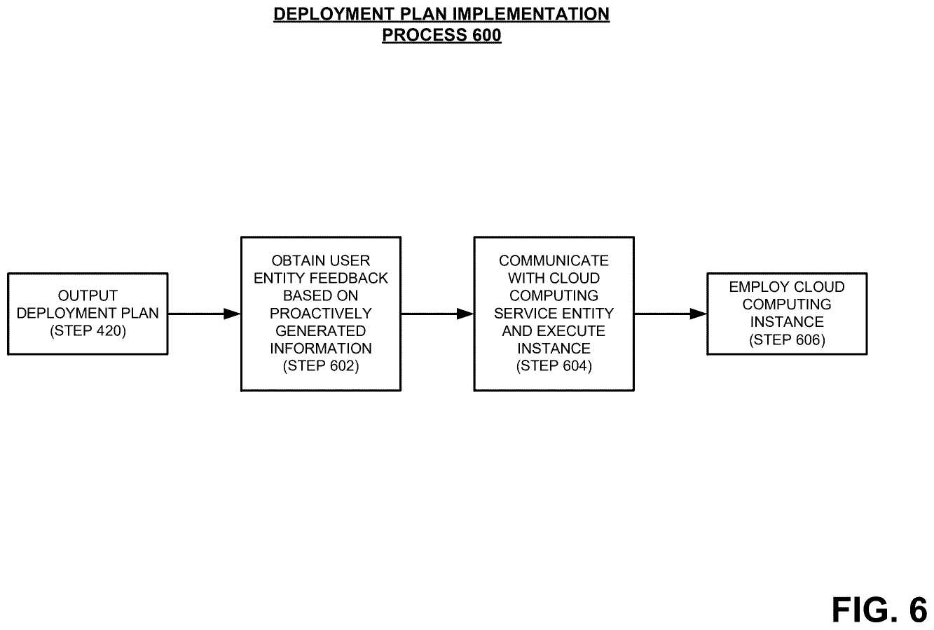

Turning now to FIG. 6, and still to continuously to FIG. 2, the sustainability data analysis system 202 can additionally and/or alternatively assist with a deployment plan implementation process 600 for implementing the deployment plan 280. For example, such implementation can comprise a step 420 of outputting the deployment plan 280, a step 602 of obtaining user entity feedback based on the proactively generated information provided in the deployment plan 280, a step 604 of communicating with a cloud computing service provider entity 506, which step can include executing/implementing a cloud computing instance 502, and/or a step 606 of employing the cloud computing instance 502. Outputting of the deployment plan 280 can be by the generating component 216 by any suitable method of communication, such as to a computing device associated with a user entity. Using the computing device, the user entity feedback can be obtained (e.g., obtaining component 210), such as accepting the deployment plan 280 and/or requesting modification by the generating component 216 to the deployment plan 280. The executing component 220 can communicate with the cloud computing service provider entity 506 to request that a cloud computing instance 502 be implemented and/or to request use of one or more operating parameters 250P, cost parameters, and/or the like. The executing component 220 can aid in one or more implementations of the cloud computing instance 502, such as by facilitating communicative coupling to the cloud computing service provider entity 506.

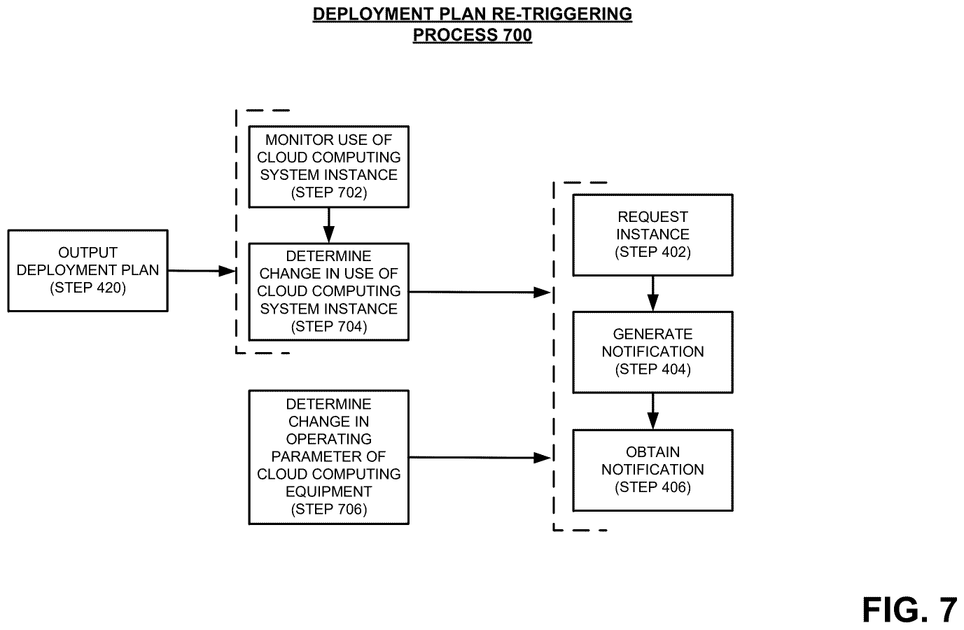

Turning now to FIG. 7, and still to continuously to FIG. 2, the sustainability data analysis system 202 can additionally and/or alternatively assist with continued deployment plan generation, through a deployment plan re-triggering process 700, allowing for a dynamic and real-time approach to maintaining sustainability of cloud computing system use by a user entity. For example, such re-triggering can comprise a step 420 of outputting the deployment plan 280, a step 702 of monitoring use of the selected cloud computing system instance 502, a step 704 of determining a change in use of the cloud computing system instance 502, and/or a step 706 of determining a change in an operating parameter of cloud computing equipment 250E associated with the cloud computing system instance 502. Outputting of the deployment plan 280 can be by the generating component 216 by any suitable method of communication, such as to a computing device associated with a user entity. The monitoring can be performed by the obtaining component 210, such as based on data/metadata available to the sustainability data analysis system 202 based on use of the selected cloud computing system instance 502. In one or more embodiments, the monitoring can result in re-generating of a sustainability level 250X of the cloud computing system instance 502, such as by the scoring component 214. The determining of a change in use (e.g., at the user entity end) can be performed by the notifying component 222, for example, as described above relative to FIG. 4 and the triggering process 400.

It is noted that step 702 can be optional, such as where a determination can be made relative to step 704 without step 702 having been implemented.

Relative to any one or more of the steps at FIG. 7, an individual step can be performed at any suitable frequency and/or upon demand, such as by receipt of a trigger from a computing device associated with a user entity and/or from another component of the sustainability data analysis system 202.

As also illustrated at FIG. 7, the steps 702 through 706 can feed into the steps 402 through 406 described above for requesting implementation of a cloud computing system instance 502 (step 402), generating a notification 290 (step 404), and/or obtaining the notification 290 (step 406). Re-description of these steps 402 through 406 is not provided here in repeat, for sake of brevity.

### Example Operations

As a first summary of the above description relative to FIGS. 1-7, turning now to FIGS. 8 to 10, a process flow comprising a set of operations for sustainability-based deployment plan generation for cloud computing is set forth. One or more elements, objects and/or components referenced in the process flow 800 can be those of schematics 100-700. Repetitive description of like elements and/or processes employed in previously described embodiments is omitted for sake of brevity.

At operation 802, the process flow 800 can comprise obtaining, by the system (e.g., obtaining component 210), specified environmental sustainability criteria (e.g., environmental sustainability criteria 260) corresponding to environmental sustainability of cloud computing.

At operation 804, the process flow 800 can comprise obtaining, by the system (e.g., obtaining component 210) the specified environmental sustainability criteria comprising respective weights (e.g., weights 260W) defining respective levels of criticality for individual ones of the environmental sustainability criteria.

At operation 806, the process flow 800 can comprise generating, by the system (e.g., scoring component 214, a sustainability score (e.g., sustainability score 270) based on an aggregation of individual scores (e.g., individual scores 260S) for individual ones of the environmental sustainability criteria.

At operation 808, the process flow 800 can comprise generating, by the system (e.g., scoring component 214), the sustainability score based on an aggregation of the respective weights for the individual ones of the environmental sustainability criteria.

At operation 810, the process flow 800 can comprise generating, by the system (e.g., scoring component 214), the sustainability score based on the respective weights wherein at least one criterion of the individual ones of the sustainability criteria has a lower weight resulting in the at least one criterion being represented according to a lower criticality level as part of the aggregation.

At operation 812, the process flow 800 can comprise configuring, by the system (e.g., generating component 216), a deployment plan (e.g., deployment plan 280) based on historical data (e.g., historical data 266D) corresponding to past sustainability results corresponding to the cloud computing equipment (e.g., cloud computing equipment 250E).

At operation 814, the process flow 800 can comprise discovering, by the system (e.g., obtaining component 210), at least one operating parameter (e.g., operating parameter 250P) of a group of operating parameters for the cloud computing equipment.

At operation 816, the process flow 800 can comprise applying, by the system (e.g., executing component 220), the at least one operating parameter of the group of operating parameters to the generating of the deployment plan for the cloud computing equipment.

At operation 818, the process flow 800 can comprise, based on the environmental sustainability criteria, generating, by the system (e.g., generating component 216), the deployment plan for cloud computing equipment of a cloud computing network that performs cloud computing.

At operation 820, the process flow 800 can comprise generating, by the system (e.g., generating component 216), the deployment plan comprising at least one configuration factor (e.g., configuration factor 280X) that defines operation of the cloud computing equipment to satisfy the environmental sustainability criteria.

At operation 821, the process flow 800 can comprise determining, by the system (e.g., generating component 216) whether the deployment plan satisfies the environmental sustainability criteria. If yes, the process flow 800 can proceed to operation 822. If not, the process flow 800 can proceed back to operation 820. For example, the use of the sustainability score 270 or individual scores 260S can be re-evaluated, such as based on weighting as compared to cost requirements 516 and/or performance requirements 514.

At operation 822, the process flow 800 can comprise, at a specified frequency, obtaining, by the system (e.g., obtaining component 210), at least one current operating parameter setting corresponding to a sustainability level (e.g., sustainability level 250X) for the cloud computing equipment.

At operation 824, the process flow 800 can comprise obtaining, by the system (e.g., obtaining component 210), a notification (e.g., notification 290) corresponding to a change in a sustainability level of the cloud computing equipment.

At operation 826, the process flow 800 can comprise, based on the obtaining of the notification, triggering (e.g., triggering component 224), by the system, a deployment plan generation to generate the deployment plan or a re-generation to generate a re-generated deployment plan.

At operation 828, the process flow 800 can comprise, based on the obtaining of a notification corresponding to a change in a sustainability level of the cloud computing equipment, generating, by the system (e.g., scoring component 214), a sustainability score based on an aggregation of individual scores for individual ones of the environmental sustainability criteria.

At operation 830, the process flow 800 can comprise employing, by the system (e.g., generating component 216), the sustainability score, executing a deployment plan re-generation resulting in a re-generated deployment plan.

At operation 832, the process flow 800 can comprise generating, by the system (e.g., generating component 216), an additional deployment plan based on a defined template (e.g., deployment plan template 262) comprising a sustainability importance rating (e.g., sustainability importance rating 262X).

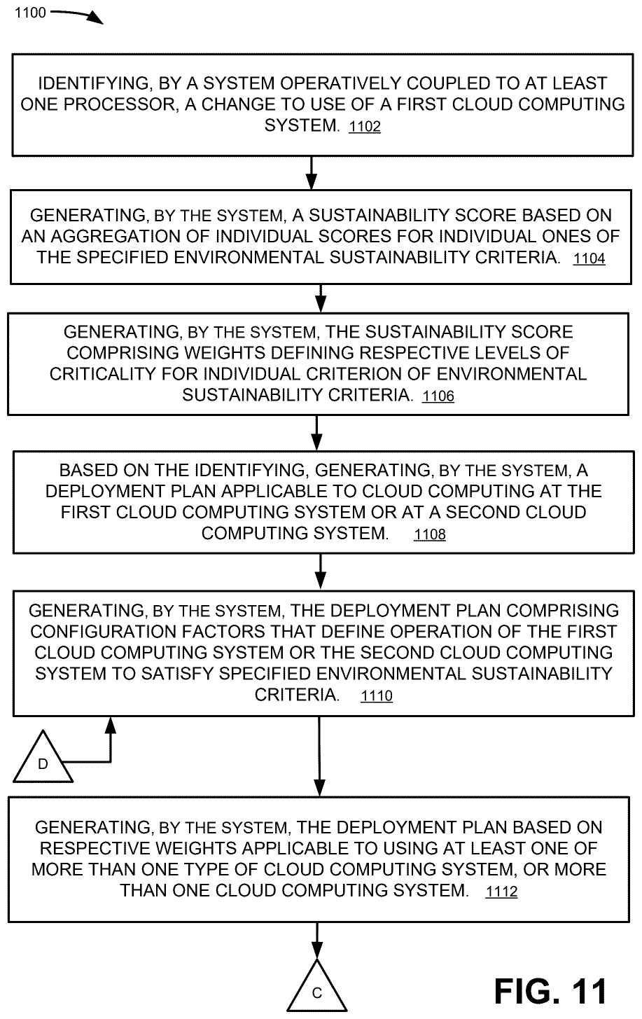

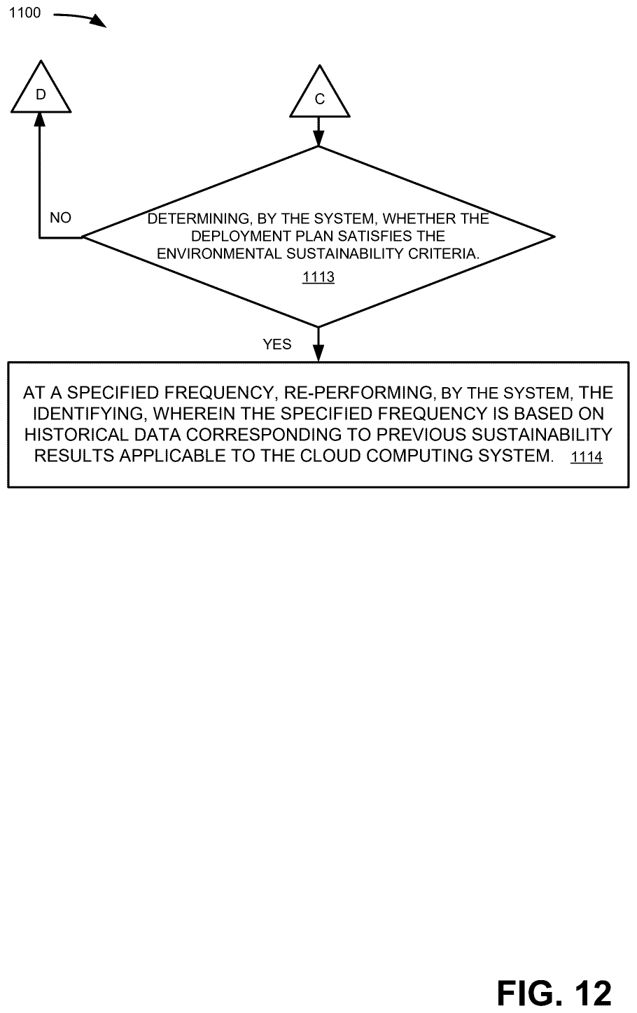

Turning now to FIGS. 11 and 12, another process flow comprising a set of operations for sustainability-based deployment plan generation for cloud computing is set forth relative to FIGS. 1-7. One or more elements, objects and/or components referenced in the process flow 1100 can be those of schematics 100-700. Repetitive description of like elements and/or processes employed in previously described embodiments is omitted for sake of brevity.

At operation 1102, the process flow 1100 can comprise identifying, by a system operatively coupled to at least one processor, a change to use of a first cloud computing system.

At operation 1104, the process flow 1100 can comprise generating, by the system, a sustainability score based on an aggregation of individual scores for individual ones of the specified environmental sustainability criteria.

At operation 1106, the process flow 1100 can comprise generating, by the system, the sustainability score comprising weights defining respective levels of criticality for individual criterion of environmental sustainability criteria.

At operation 1108, the process flow 1100 can comprise, based on the identifying, generating, by the system, a deployment plan applicable to cloud computing at the first cloud computing system or at a second cloud computing system.

At operation 1110, the process flow 1100 can comprise generating, by the system, the deployment plan comprising configuration factors that define operation of the first cloud computing system or the second cloud computing system to satisfy specified environmental sustainability criteria.

At operation 1112, the process flow 1100 can comprise generating, by the system, the deployment plan based on respective weights applicable to using at least one of more than one type of cloud computing system, or more than one cloud computing system.

At operation 1113, the process flow 800 can comprise determining, by the system (e.g., generating component 216) whether the deployment plan satisfies the environmental sustainability criteria. If yes, the process flow 1100 can proceed to operation 1114. If not, the process flow 1100 can proceed back to operation 1110. For example, the use of the sustainability score 270 or individual scores 260S can be re-evaluated, such as based on weighting as compared to cost requirements 516 and/or performance requirements 514.

At operation 1114, the process flow 1100 can comprise, at a specified frequency, re-performing, by the system, the identifying, wherein the specified frequency is based on historical data corresponding to previous sustainability results applicable to the cloud computing system.

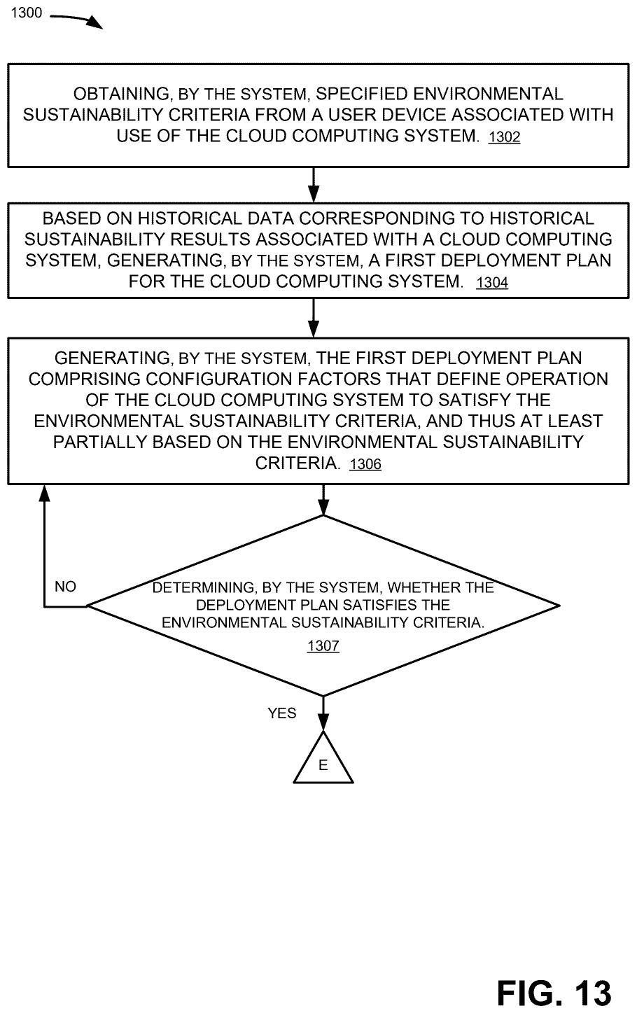

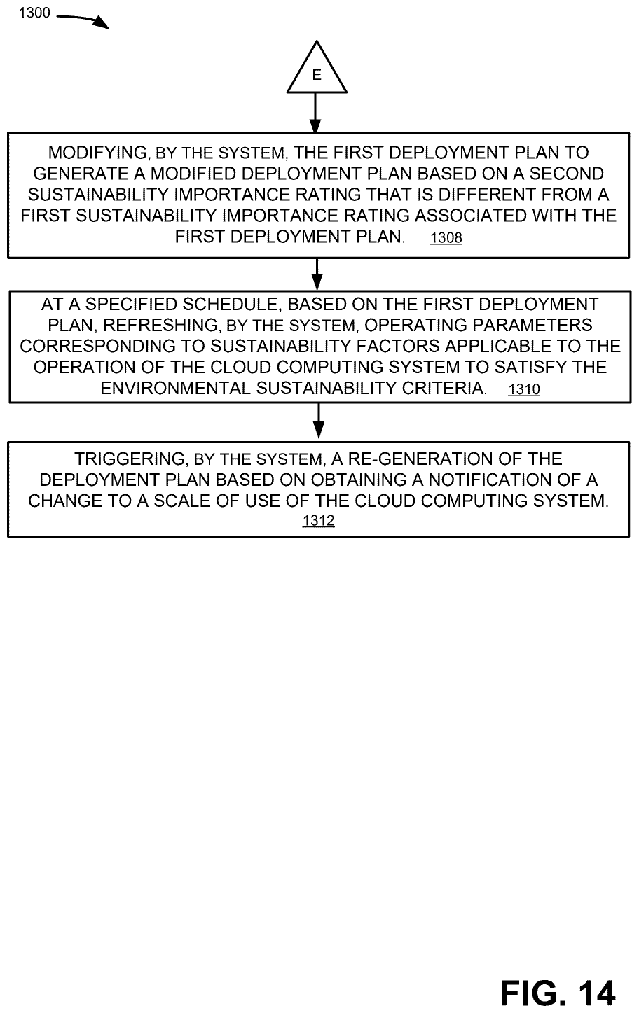

Turning now to FIGS. 13 and 14, still another process flow comprising a set of operations for sustainability-based deployment plan generation for cloud computing is set forth relative to FIGS. 1-7. One or more elements, objects and/or components referenced in the process flow 1300 can be those of schematics 100-700. Repetitive description of like elements and/or processes employed in previously described embodiments is omitted for sake of brevity.

At operation 1302, the process flow 1300 can comprise obtaining, by the system, specified environmental sustainability criteria from a user device associated with use of the cloud computing system.

At operation 1304, the process flow 1300 can comprise, based on historical data corresponding to historical sustainability results associated with a cloud computing system, generating, by the system, a first deployment plan for the cloud computing system.

At operation 1306, the process flow 1300 can comprise generating, by the system, the first deployment plan comprising configuration factors that define operation of the cloud computing system to satisfy the environmental sustainability criteria, and thus at least partially based on the environmental sustainability criteria.

At operation 1307, the process flow 1300 can comprise determining, by the system (e.g., generating component 216) whether the deployment plan satisfies the environmental sustainability criteria. If yes, the process flow 1300 can proceed to operation 1308. If not, the process flow 1300 can proceed back to operation 1306. For example, the use of the sustainability score 270 or individual scores 260S can be re-evaluated, such as based on weighting as compared to cost requirements 516 and/or performance requirements 514.

At operation 1308, the process flow 1300 can comprise modifying, by the system, the first deployment plan to generate a modified deployment plan based on a second sustainability importance rating that is different from a first sustainability importance rating associated with the first deployment plan.

At operation 1310, the process flow 1300 can comprise, at a specified schedule, based on the first deployment plan, refreshing, by the system, operating parameters corresponding to sustainability factors applicable to the operation of the cloud computing system to satisfy the environmental sustainability criteria.

At operation 1312, the process flow 1300 can comprise triggering, by the system, a re-generation of the deployment plan based on obtaining a notification of a change to a scale of use of the cloud computing system.

For simplicity of explanation, the computer-implemented methodologies and/or processes provided herein are depicted and/or described as a series of acts. The subject innovation is not limited by the acts illustrated and/or by the order of acts, for example acts can occur in one or more orders and/or concurrently, and with other acts not presented and described herein. The operations of process flows of the figures provided herein are example operations, and there can be one or more embodiments that implement more or fewer operations than are depicted.

Furthermore, not all illustrated acts can be utilized to implement the computer-implemented methodologies in accordance with the described subject matter. In addition, the computer-implemented methodologies could alternatively be represented as a series of interrelated states via a state diagram or events. Additionally, the computer-implemented methodologies described hereinafter and throughout this specification are capable of being stored on an article of manufacture to facilitate transporting and transferring the computer-implemented methodologies to computers. The term article of manufacture, as used herein, is intended to encompass a computer program accessible from any machine-readable device or storage media.

In summary, described is technology that facilitates refreshing of cloud computing equipment in accordance with a deployment plan to satisfy specified environmental sustainability criteria. An associated method comprises identifying, by a system operatively coupled to at least one processor, a change to use of a first cloud computing system, and based on the identifying, generating a deployment plan applicable to cloud computing at the first cloud computing system or at a second cloud computing system, wherein the deployment plan comprises configuration factors that define operation of the first cloud computing system or the second cloud computing system to satisfy specified environmental sustainability criteria.

An example benefit of one or more of the above-indicated method, system and/or non-transitory computer-readable medium can be an ability to provide flexible decision-making information to a user entity of the cloud computing equipment, such as an administrating entity. This information can be flexible because it can be obtained and/or provided before making a decision and further at a specified frequency after making a decision, thus allowing for dynamic changes (e.g., additional decisions as to cloud networking equipment). The information can include sustainability scores, criticality levels of particular sustainability criteria, cloud computing equipment operating parameters applicable to the sustainability score, etc.

The dynamic nature of the one or more embodiments described herein can be provided by automatically generating and/or obtaining a notification of a change of an operating parameter of cloud networking equipment being employed or of a change to a key performance indicator being monitored either on the provider-end (e.g., provider of the cloud networking system) and/or at the user-end (e.g., user entity of the cloud networking system).

Furthermore, in one or more embodiments, the above-indicated method, system and/or non-transitory computer-readable medium can function relative to multi-cloud deployment, and/or with any combination of private cloud equipment/systems and/or public cloud equipment/systems.

Another example benefit of one or more of the above-indicated method, system and/or non-transitory computer-readable medium can be an ability to provide automatic deployment plan generation based on receipt of a notification and/or upon triggering of the deployment plan generation. Such notification can be sent based on change of scale of use of the cloud networking system, change in an operation parameter of the cloud networking system, and/or change in a sustainability level applicable to the cloud networking system. Additionally, and/or alternatively, such notification can be sent based on any one or more of these noted factors relative to a different cloud networking system not being used, but perhaps being evaluated for a future deployment. Such triggering can be provided automatically and/or based on user entity input.

Indeed, in view of the one or more embodiments described herein, a practical application of above-indicated method, system and/or non-transitory computer-readable medium can be an ability to generate quantitively defined, sustainability-focused scoring that is dynamically adjustable based on one or more changes in sustainability preferences of a user, changes in use and/or operation of a cloud computing system, and/or changes in scaling related to use of a cloud computing system by a user entity. This sustainability scoring can be applicable both upstream of a cloud deployment, such as for use in generating a cloud deployment plan, and/or downstream of a cloud deployment, such as for monitoring a cloud computing system after implementation of a cloud deployment plan. As a result, cloud deployment decisions can be made proactively, such as before cloud deployment based on a generated cloud deployment plan, rather than reactively as with existing frameworks. As described above, such cloud deployment decisions can comprise, but are not limited to, cloud computing service providers, cloud computing hardware and/or software to employ, and/or whether to employ a private and/or public cloud architecture.

These are useful and practical applications of computers, thus providing enhanced (e.g., improved and/or optimized) operation of the hardware and/or software components for use with a cloud computing system. Indeed, a cloud deployment plan can affect use and/or architecture at the user entity-side, thus allowing for such use and/or architecture to be self-improving relative to environmental sustainability as discussed herein. That is, by proactively gathering, analyzing and make one or more decisions based upon sustainability criteria related to environmental sustainability of a cloud computing system, not only can decisions be made prior to day 0 operations, but operations at the user-entity side, interfacing with a cloud computing system, can be optimized, allowing for a user entity's computing architecture to be self-improving. Overall, such tools can constitute a concrete and tangible technical and/or physical improvement in the fields of cloud computing and environmentally sustainable computing more generally.

Furthermore, one or more embodiments described herein can be employed in a real-world system based on the disclosed teachings. For example, one or more embodiments described herein can function with a computer system and/or one or more servers for internet, cloud and/or internal/external networks to perform the one or more deployment plan generation processes discussed herein.

Further, one or more embodiments described herein are inherently and/or inextricably tied to computer technology and cannot be implemented outside of a computing environment. For example, one or more processes performed by one or more embodiments described herein can more efficiently, and even more feasibly, gather and/or employ sustainability criteria for cloud computing deployment as compared to existing systems and/or techniques. Systems, computer-implemented methods and/or computer program products facilitating performance of these processes are of great utility in the fields of cloud computing and environmentally sustainable information technology services and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively operate processes that perform the sustainability-focused scored processes as the one or more embodiments described herein can facilitate these processes. And, neither can the human mind nor a human with pen and paper automatically perform one or more of the processes as conducted by one or more embodiments described herein.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not described herein for the sake of brevity, but known by those of skill in the art.

In one or more embodiments, one or more of the processes described herein can be performed by one or more specialized computers (e.g., a specialized processing unit, a specialized classical computer, and/or another type of specialized computer) to execute defined tasks related to the one or more technologies describe above. One or more embodiments described herein and/or components thereof can be employed to solve new problems that arise through advancements in technologies mentioned above, employment of cloud operation systems, computer architecture and/or another technology.

One or more embodiments described herein can be fully operational towards performing one or more other functions (e.g., fully powered on, fully executed and/or another function) while also performing the one or more operations described herein.

The paragraphs that follow provide additional summary reciting a system, a method and a computer-readable medium.

A system can comprise: at least one processor; and at least one memory that stores executable instructions that, when executed by the at least one processor, facilitate performance of operations, comprising: obtaining specified environmental sustainability criteria corresponding to environmental sustainability of cloud computing; and based on the environmental sustainability criteria, generating a deployment plan for cloud computing equipment of a cloud computing network that performs cloud computing, wherein the deployment plan comprises at least one configuration factor that defines operation of the cloud computing equipment to satisfy the environmental sustainability criteria.

For the system of the preceding paragraph, the operations can further comprise: generating a sustainability score based on an aggregation of individual scores for individual ones of the environmental sustainability criteria.

For the system of any preceding paragraph, the environmental sustainability criteria can comprise respective weights defining respective levels of criticality for individual ones of the environmental sustainability criteria.

For the system of any preceding paragraph, the operations can further comprise: generating a sustainability score based on an aggregation of the respective weights for the individual ones of the environmental sustainability criteria, wherein at least one criterion of the individual ones of the sustainability criteria has a lower weight resulting in the at least one criterion being represented according to a lower criticality level as part of the aggregation.

For the system of any preceding paragraph, the operations can further comprise: configuring the deployment plan based on historical data corresponding to past sustainability results corresponding to the cloud computing equipment.

For the system of any preceding paragraph, the operations can further comprise: discovering at least one operating parameter of a group of operating parameters for the cloud computing equipment; and applying the at least one operating parameter of the group of operating parameters to the generating of the deployment plan for the cloud computing equipment.

For the system of any preceding paragraph, the operations can further comprise: at a specified frequency, obtaining at least one current operating parameter setting corresponding to a sustainability level for the cloud computing equipment.

For the system of any preceding paragraph, the operations can further comprise: obtaining a notification corresponding to a change in a sustainability level of the cloud computing equipment; and based on the obtaining of the notification, triggering a deployment plan generation to generate the deployment plan or a re-generation to generate a re-generated deployment plan.

For the system of any preceding paragraph, the operations can further comprise: based on the obtaining of a notification corresponding to a change in a sustainability level of the cloud computing equipment, generating a sustainability score based on an aggregation of individual scores for individual ones of the environmental sustainability criteria; and employing the sustainability score, executing a deployment plan re-generation resulting in a re-generated deployment plan.

For the system of any preceding paragraph, the operations can further comprise: generating an additional deployment plan based on a defined template comprising sustainability importance rating.

A method can comprise: identifying, by a system operatively coupled to at least one processor, a change to use of a first cloud computing system; and based on the identifying, generating a deployment plan applicable to cloud computing at the first cloud computing system or at a second cloud computing system, wherein the deployment plan comprises configuration factors that define operation of the first cloud computing system or the second cloud computing system to satisfy specified environmental sustainability criteria.

The method of the preceding paragraph can further comprise: generating a sustainability score based on an aggregation of individual scores for individual ones of the specified environmental sustainability criteria.

With respect to the method of any preceding paragraph, the environmental sustainability criteria can comprise weights defining respective levels of criticality for individual criterion of environmental sustainability criteria.

The method of any preceding paragraph can further comprise: at a specified frequency, re-performing the identifying, wherein the specified frequency is based on historical data corresponding to previous sustainability results applicable to the cloud computing system.

With respect to the method of any preceding paragraph, the generating of the deployment plan can comprise generating the deployment plan based on respective weights applicable to using at least one of more than one type of cloud computing system, or more than one cloud computing system.

A non-transitory machine-readable medium can be implemented, comprising executable instructions that, when executed by at least one processor, facilitate performance of operations, comprising: based on historical data corresponding to historical sustainability results associated with a cloud computing system, generating a first deployment plan for the cloud computing system, wherein the first deployment plan comprises configuration factors that define operation of the cloud computing system to satisfy environmental sustainability criteria, and modifying the first deployment plan to generate a modified deployment plan based on a second sustainability importance rating that is different from a first sustainability importance rating associated with the first deployment plan.

For the non-transitory machine-readable medium of the preceding paragraph, the operations can further comprise: from a user device associated with use of the cloud computing system, obtaining the environmental sustainability criteria; and generating the first deployment plan at least partially based on the environmental sustainability criteria.

For the non-transitory machine-readable medium of any preceding paragraph, the environmental sustainability criteria comprise respective weights defining respective levels of criticality for individual ones of the environmental sustainability criteria.

For the non-transitory machine-readable medium of any preceding paragraph, the operations can further comprise: at a specified schedule, based on the first deployment plan, refreshing operating parameters corresponding to sustainability factors applicable to the operation of the cloud computing system to satisfy the environmental sustainability criteria.

For the non-transitory machine-readable medium of any preceding paragraph, the operations can further comprise: triggering a re-generation of the deployment plan based on obtaining a notification of a change to a scale of use of the cloud computing system.

### Example Operating Environment

FIG. 15 is a schematic block diagram of an operating environment 1500 with which the described subject matter can interact. The operating environment 1500 comprises one or more remote component(s) 1510. The remote component(s) 1510 can be hardware and/or software (e.g., threads, processes, computing devices). In one or more embodiments, remote component(s) 1510 can be a distributed computer system, connected to a local automatic scaling component and/or programs that use the resources of a distributed computer system, via communication framework 1540. Communication framework 1540 can comprise wired network devices, wireless network devices, mobile devices, wearable devices, radio access network devices, gateway devices, femtocell devices, servers, etc.

The operating environment 1500 also comprises one or more local component(s) 1520. The local component(s) 1520 can be hardware and/or software (e.g., threads, processes, computing devices). In one or more embodiments, local component(s) 1520 can comprise an automatic scaling component and/or programs that communicate/use the remote resources 1510 and 1520, etc., connected to a remotely located distributed computing system via communication framework 1540.

One possible communication between a remote component(s) 1510 and a local component(s) 1520 can be in the form of a data packet adapted to be transmitted between two or more computer processes. Another possible communication between a remote component(s) 1510 and a local component(s) 1520 can be in the form of circuit-switched data adapted to be transmitted between two or more computer processes in radio time slots. The operating environment 1500 comprises a communication framework 1540 that can be employed to facilitate communications between the remote component(s) 1510 and the local component(s) 1520, and can comprise an air interface, e.g., interface of a UMTS network, via an LTE network, etc. Remote component(s) 1510 can be operably connected to one or more remote data store(s) 1550, such as a hard drive, solid state drive, subscriber identity module (SIM) card, electronic SIM (eSIM), device memory, etc., that can be employed to store information on the remote component(s) 1510 side of communication framework 1540. Similarly, local component(s) 1520 can be operably connected to one or more local data store(s) 1530, that can be employed to store information on the local component(s) 1520 side of communication framework 1540.

### Example Computing Environment

In order to provide additional context for various embodiments described herein, FIG. 16 and the following discussion are intended to provide a brief, general description of a suitable computing environment 1600 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform tasks or implement abstract data types. Moreover, the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Referring still to FIG. 16, the example computing environment 1600 which can implement one or more embodiments described herein includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures can also be employed as the processing unit 1604.

The system bus 1608 can be any of several types of bus structure that can further interconnect to a memory bus (with or without a memory controller), a peripheral bus, and a local bus using any of a variety of commercially available bus architectures. The system memory 1606 includes ROM 1610 and RAM 1612. A basic input/output system (BIOS) can be stored in a non-volatile memory such as ROM, erasable programmable read only memory (EPROM), EEPROM, which BIOS contains the basic routines that help to transfer information between elements within the computer 1602, such as during startup. The RAM 1612 can also include a high-speed RAM such as static RAM for caching data.

The computer 1602 further includes an internal hard disk drive (HDD) 1614 (e.g., EIDE, SATA), and can include one or more external storage devices 1616 (e.g., a magnetic floppy disk drive (FDD) 1616, a memory stick or flash drive reader, a memory card reader, etc.). While the internal HDD 1614 is illustrated as located within the computer 1602, the internal HDD 1614 can also be configured for external use in a suitable chassis (not shown). Additionally, while not shown in computing environment 1600, a solid-state drive (SSD) could be used in addition to, or in place of, an HDD 1614.

Other internal or external storage can include at least one other storage device 1620 with storage media 1622 (e.g., a solid-state storage device, a nonvolatile memory device, and/or an optical disk drive that can read or write from removable media such as a CD-ROM disc, a DVD, a BD, etc.). The external storage 1616 can be facilitated by a network virtual machine. The HDD 1614, external storage device 1616 and storage device (e.g., drive) 1620 can be connected to the system bus 1608 by an HDD interface 1624, an external storage interface 1626 and a drive interface 1628, respectively.

The drives and their associated computer-readable storage media provide nonvolatile storage of data, data structures, computer-executable instructions, and so forth. For the computer 1602, the drives and storage media accommodate the storage of any data in a suitable digital format. Although the description of computer-readable storage media above refers to respective types of storage devices, other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. The systems and methods described herein can be implemented utilizing various commercially available operating systems or combinations of operating systems.

Computer 1602 can optionally comprise emulation technologies. For example, a hypervisor (not shown) or other intermediary can emulate a hardware environment for operating system 1630, and the emulated hardware can optionally be different from the hardware illustrated in FIG. 16. In such an embodiment, operating system 1630 can comprise one virtual machine (VM) of multiple VMs hosted at computer 1602. Furthermore, operating system 1630 can provide runtime environments, such as the Java runtime environment or the .NET framework, for applications 1632. Runtime environments are consistent execution environments that allow applications 1632 to run on any operating system that includes the runtime environment. Similarly, operating system 1630 can support containers, and applications 1632 can be in the form of containers, which are lightweight, standalone, executable packages of software that include, e.g., code, runtime, system tools, system libraries and settings for an application.

Further, computer 1602 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1602, e.g., applied at the application execution level or at the operating system (OS) kernel level, thereby enabling security at any level of code execution.

A user can enter commands and information into the computer 1602 through one or more wired/wireless input devices, e.g., a keyboard 1638, a touch screen 1640, and a pointing device, such as a mouse 1642. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera, a gesture sensor input device, a vision movement sensor input device, an emotion or facial detection device, a biometric input device, e.g., fingerprint or iris scanner, or the like. These and other input devices are often connected to the processing unit 1604 through an input device interface 1644 that can be coupled to the system bus 1608, but can be connected by other interfaces, such as a parallel port, an IEEE 1394 serial port, a game port, a USB port, an IR interface, a BLUETOOTH® interface, etc.

A monitor 1646 or other type of display device can also be connected to the system bus 1608 via an interface, such as a video adapter 1648. In addition to the monitor 1646, a computer typically includes other peripheral output devices (not shown), such as speakers, printers, etc.

The computer 1602 can operate in a networked environment using logical connections via wired and/or wireless communications to one or more remote computers, such as a remote computer 1650. The remote computer 1650 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1652 is illustrated. The logical connections depicted include wired/wireless connectivity to a local area network (LAN) 1654 and/or larger networks, e.g., a wide area network (WAN) 1656. Such LAN and WAN networking environments are commonplace in offices and companies, and facilitate enterprise-wide computer networks, such as intranets, all of which can connect to a global communications network, e.g., the Internet.

When used in a LAN networking environment, the computer 1602 can be connected to the local network 1654 through a wired and/or wireless communication network interface or adapter 1658. The adapter 1658 can facilitate wired or wireless communication to the LAN 1654, which can also include a wireless access point (AP) disposed thereon for communicating with the adapter 1658 in a wireless mode.

When used in a WAN networking environment, the computer 1602 can include a modem 1660 or can be connected to a communications server on the WAN 1656 via other means for establishing communications over the WAN 1656, such as by way of the Internet. The modem 1660, which can be internal or external and a wired or wireless device, can be connected to the system bus 1608 via the input device interface 1644. In a networked environment, program modules depicted relative to the computer 1602 or portions thereof, can be stored in the remote memory/storage device 1652. The network connections shown are example and other means of establishing a communications link between the computers can be used.

When used in either a LAN or WAN networking environment, the computer 1602 can access cloud storage systems or other network-based storage systems in addition to, or in place of, external storage devices 1616 as described above. Generally, a connection between the computer 1602 and a cloud storage system can be established over a LAN 1654 or WAN 1656 e.g., by the adapter 1658 or modem 1660, respectively. Upon connecting the computer 1602 to an associated cloud storage system, the external storage interface 1626 can, with the aid of the adapter 1658 and/or modem 1660, manage storage provided by the cloud storage system as it would other types of external storage. For instance, the external storage interface 1626 can be configured to provide access to cloud storage sources as if those sources were physically connected to the computer 1602.

The computer 1602 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a defined structure as with a conventional network or simply an ad hoc communication between at least two devices.

### CONCLUSION

The above description of illustrated embodiments of the one or more embodiments described herein, comprising what is described in the Abstract, is not intended to be exhaustive or to limit the described embodiments to the precise forms described. While one or more specific embodiments and examples are described herein for illustrative purposes, various modifications are possible that are considered within the scope of such embodiments and examples, as those skilled in the relevant art can recognize.

In this regard, while the described subject matter has been described in connection with various embodiments and corresponding figures, where applicable, other similar embodiments can be used or modifications and additions can be made to the described embodiments for performing the same, similar, alternative, or substitute function of the described subject matter without deviating therefrom. Therefore, the described subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures to optimize space usage or enhance performance of user equipment. A processor can also be implemented as a combination of computing processing units.

As used in this application, the terms “component,” “system,” “platform,” “layer,” “selector,” “interface,” and the like are intended to refer to a computer-related entity or an entity related to an operational apparatus with one or more functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of these instances.

While the embodiments are susceptible to various modifications and alternative constructions, certain illustrated implementations thereof are shown in the drawings and have been described above in detail. However, there is no intention to limit the various embodiments to the one or more specific forms described, but on the contrary, the intention is to cover all modifications, alternative constructions, and equivalents falling within the spirit and scope.

In addition to the various implementations described herein, other similar implementations can be used, or modifications and additions can be made to the described implementation for performing the same or equivalent function of the corresponding implementation without deviating therefrom. Still further, multiple processing chips or multiple devices can share the performance of one or more functions described herein, and similarly, storage can be implemented across different devices. Accordingly, the various embodiments are not to be limited to any single implementation, but rather are to be construed in breadth, spirit, and scope in accordance with the appended claims.

What is claimed is:

1. A system, comprising:
at least one processor; and
at least one memory that stores executable instructions that, when executed by the at least one processor, facilitate performance of operations, comprising:
obtaining specified environmental sustainability criteria corresponding to environmental sustainability of cloud computing; and
based on the environmental sustainability criteria, generating a deployment plan for cloud computing equipment of a cloud computing network that performs cloud computing,
wherein the deployment plan comprises at least one configuration factor that defines operation of the cloud computing equipment to satisfy the environmental sustainability criteria.

2. The system of claim 1, wherein the operations further comprise:
generating a sustainability score based on an aggregation of individual scores for individual ones of the environmental sustainability criteria.

3. The system of claim 1, wherein the environmental sustainability criteria comprise respective weights defining respective levels of criticality for individual ones of the environmental sustainability criteria.

4. The system of claim 3, wherein the operations further comprise:
generating a sustainability score based on an aggregation of the respective weights for the individual ones of the environmental sustainability criteria,
wherein at least one criterion of the individual ones of the sustainability criteria has a lower weight resulting in the at least one criterion being represented according to a lower criticality level as part of the aggregation.

5. The system of claim 1, wherein the operations further comprise:
configuring the deployment plan based on historical data corresponding to past sustainability results corresponding to the cloud computing equipment.

6. The system of claim 1, wherein the operations further comprise:
discovering at least one operating parameter of a group of operating parameters for the cloud computing equipment; and
applying the at least one operating parameter of the group of operating parameters to the generating of the deployment plan for the cloud computing equipment.

7. The system of claim 1, wherein the operations further comprise:
at a specified frequency, obtaining at least one current operating parameter setting corresponding to a sustainability level for the cloud computing equipment.

8. The system of claim 1, wherein the operations further comprise:
obtaining a notification corresponding to a change in a sustainability level of the cloud computing equipment; and
based on the obtaining of the notification, triggering a deployment plan generation to generate the deployment plan or a re-generation to generate a re-generated deployment plan.

9. The system of claim 1, wherein the operations further comprise:
based on the obtaining of a notification corresponding to a change in a sustainability level of the cloud computing equipment, generating a sustainability score based on an aggregation of individual scores for individual ones of the environmental sustainability criteria; and
employing the sustainability score, executing a deployment plan re-generation resulting in a re-generated deployment plan.

10. The system of claim 1, wherein the operations further comprise:
generating an additional deployment plan based on a defined template comprising sustainability importance rating.

11. A method, comprising:
identifying, by a system operatively coupled to at least one processor, a change to use of a first cloud computing system; and
based on the identifying, generating a deployment plan applicable to cloud computing at the first cloud computing system or at a second cloud computing system,
wherein the deployment plan comprises configuration factors that define operation of the first cloud computing system or the second cloud computing system to satisfy specified environmental sustainability criteria.

12. The method of claim 11, further comprising:
generating a sustainability score based on an aggregation of individual scores for individual ones of the specified environmental sustainability criteria.

13. The method of claim 11, wherein the environmental sustainability criteria comprise weights defining respective levels of criticality for individual criterion of environmental sustainability criteria.

14. The method of claim 11, further comprising:
at a specified frequency, re-performing the identifying,
wherein the specified frequency is based on historical data corresponding to previous sustainability results applicable to the cloud computing system.

15. The method of claim 11, wherein the generating of the deployment plan comprises generating the deployment plan based on respective weights applicable to using at least one of more than one type of cloud computing system, or more than one cloud computing system.

16. A non-transitory machine-readable medium, comprising executable instructions that, when executed by at least one processor facilitate performance of operations, comprising:
based on historical data corresponding to historical sustainability results associated with a cloud computing system, generating a first deployment plan for the cloud computing system,
wherein the first deployment plan comprises configuration factors that define operation of the cloud computing system to satisfy environmental sustainability criteria, and
modifying the first deployment plan to generate a modified deployment plan based on a second sustainability importance rating that is different from a first sustainability importance rating associated with the first deployment plan.

17. The non-transitory machine-readable medium of claim 16, the operations further comprising:
from a user device associated with use of the cloud computing system, obtaining the environmental sustainability criteria; and
generating the first deployment plan at least partially based on the environmental sustainability criteria.

18. The non-transitory machine-readable medium of claim 17, wherein the environmental sustainability criteria comprise respective weights defining respective levels of criticality for individual ones of the environmental sustainability criteria.

19. The non-transitory machine-readable medium of claim 16, the operations further comprising:
at a specified schedule, based on the first deployment plan, refreshing operating parameters corresponding to sustainability factors applicable to the operation of the cloud computing system to satisfy the environmental sustainability criteria.

20. The non-transitory machine-readable medium of claim 16, the operations further comprising:
triggering a re-generation of the deployment plan based on obtaining a notification of a change to a scale of use of the cloud computing system.
